(19) United States
(12) Patent Application Publication
(10) Pub. No.: US 2012/0229575 A1
(43) Pub. Date: Sep. 13, 2012

(54) INK FOR INK JET RECORDING

(75) Inventors: Masayuki Ikegami, Atsugi-shi (JP); Ikuo Nakazawa, Kawasaki-shi (JP)

(73) Assignee: CANON KABUSHIKI KAISHA, Tokyo (JP)

(21) Appl. No.: 13/511,341

(22) PCT Filed: Nov. 22, 2010
(86) PCT No.: PCT/JP2010/006821

§ 371 Date: May 22, 2012

(30) Foreign Application Priority Data
Nov. 25, 2009 (JP) 2009-267730
Oct. 13, 2010 (JP) 2010-230727

(51) Int. Cl. B41J 2/05; C09D 11/10

(52) U.S. Cl. 347/56; 524/599

(57) ABSTRACT

An ink for ink jet recording, the ink being used in an ink jet recording method that includes ejecting an ink from a recording head by the action of thermal energy, includes water, a self-dispersing pigment, and polymer particles, in which the polymer particles have a glass transition temperature of 25 degrees (Celsius) or lower, an average particle size of 80 nm to 220 nm, and an acid value of 25 mgKOH/g to 150 mgKOH/g.

### TECHNICAL FIELD

The present invention relates to an ink for ink jet recording.

### BACKGROUND ART

Ink for inkjet recording has been required to improve fastness properties, such as highlighter resistance and scratch resistance, after the application of ink on a recording medium. To satisfy the requirement, it has been known that polymer particles are added to ink to improve the fastness properties. The addition of the polymer particles improves binding properties between a coloring material and a recording medium or between coloring materials, improving the fastness properties.

PTL 1 discloses ink that contains additional polymer particles each having a particle size 1 to 1.5 times that of pigment particles to improve reliability, e.g., clogging resistance of an ink composition in a recording apparatus. PTL 2 discloses ink in which the glass transition temperature and the particle size of polymer particles and the mass proportion of an acid component in the polymer particles are specified to improve highlighter resistance and printability.

For each of the inks described in PTL 1 and PTL 2, however, the ink sometimes has insufficient dispersion stability because of the addition of the polymer particles therein. Furthermore, when the ink is used in an ink jet recording method (a thermal ink jet recording method) that includes ejecting and flying ink from a recording head by the action of thermal energy to perform recording, the ejection is not stabilized, in some cases. This may be because a deposit is formed by the effect of an increase in the viscosity of the ink due to the addition of the polymer particles and heat generated by applying pulses to the ink That is, in order to stably eject ink, the following requirements need to be satisfied: the increase in the viscosity of the ink due to the addition of polymer particles is suppressed; and the ink has the capabilities of foaming on a thin-film resistor in a desired volume and repeating foaming and defoaming in a desired period of time.

### CITATION LIST

### Patent Literature

PTL 1: Japanese Patent Laid-Open No. 2004-238445

PTL 2: Japanese Patent Laid-Open No. 2001-240619

### SUMMARY OF INVENTION

Accordingly, the present invention provides an ink for ink jet recording, the ink having excellent fastness property and being capable of being stably dispersed and stably ejected even when the ink is ejected by thermal energy.

Aspects of the present invention described below overcome the foregoing problems. According to one aspect of the present invention, an ink for ink jet recording, the ink being used in an ink jet recording method that includes ejecting an ink from a recording head by the action of thermal energy, includes water, a self-dispersing pigment, and polymer particles, in which the polymer particles have a glass transition temperature of 25 degrees (Celsius) or lower, an average particle size of 80 nm to 220 nm, and an acid value of 25 mgKOH/g to 150 mgKOH/g.

According to aspects of the present invention, there is provided an ink for ink jet recording, the ink having excellent fastness property and being capable of being stably dispersed and stably ejected even when the ink is ejected by thermal energy.

### BRIEF DESCRIPTION OF DRAWINGS

FIG. 1 illustrates an example of a method for forming a recording dot.

FIG. 2 illustrates an ink jet recording apparatus.

FIG. 3 illustrates a recording head of the serial type.

FIG. 4 illustrates a recording head of the line type.

### DESCRIPTION OF EMBODIMENTS

The present invention will be described in further detail below by embodiments.

### Ink

### Coloring Material

An ink for ink jet recording according to aspects of the present invention contains a self-dispersing pigment as a coloring material. According to aspects of the present invention, the self-dispersing pigment is used, thus resulting in satisfactory water-fastness. Furthermore, since the ink contains the self-dispersing pigment, solid-liquid separation proceeds smoothly after the landing of the ink on paper, thereby improving color developability. Moreover, solid-liquid separation proceeds more smoothly by the synergistic effect of the self-dispersing pigment in the ink and application conditions of the ink described below, as compared with, for example, the case where a pigment is used in a polymer dispersion method. This is unlikely to cause the pigment itself to penetrate deeply into the inside of a recording medium, thereby significantly improving color developability.

Basically, the self-dispersing pigment does not require a dispersant and is a pigment in which a hydrophilic group is introduced directly or through another atomic group onto the surface of each of particles of the pigment, so that the dispersion of the pigment is stabilized. As a pigment to be formed into the self-dispersing pigment by the stabilization treatment, for example, various known pigments listed in WO 2009/014242 may be used. The hydrophilic group that is introduced into such a pigment to be formed into the self-dispersing pigment may be directly bonded to the surface of each of the pigment particles or may be indirectly bonded to the surface of each of the pigment particles through another atomic group provided between the surface of each pigment particle and the hydrophilic group.

A self-dispersing pigment in which an acidic functional group is bonded to the surface of each particle of the pigment directly or through an atomic group is stably dispersed in ink without using a polymer or a dispersant such as a surfactant because a proton is dissociated from the acidic functional group at a specific pH to form an anionic hydrophilic group. Examples of the anionic hydrophilic group include —PO₃(M)₂, —COOM, and —SO₃M (wherein M represents a hydrogen atom, an alkali metal, ammonium, or organic ammonium). Specific examples of the alkali metal represented by “M” in the hydrophilic groups include Li, Na, K, Rb, and Cs. Specific examples of the organic ammonium include methylammonium, dimethylammonium, trimethylammonium, ethylammonium, diethylammonium, triethylammonium, monohydroxymethyl(ethyl)amine, dihydroxymethyl(ethyl)amine, and trihydroxymethyl(ethyl)amine.

Specific examples of another atomic group provided between the surface of each pigment particle and the hydrophilic group include linear or branched alkylene groups each having 1 to 12 carbon atoms, substituted or unsubstituted phenylene groups, and substituted or unsubstituted naphthylene groups. Examples of substituents on phenylene groups and naphthylene groups include linear or branched alkyl groups having 1 to 6 carbon atoms.

A specific example of the self-dispersing pigment contained in the ink for ink jet recording according to aspects of the present invention is a self-dispersing pigment in which the surface of each of the particles of the pigment is modified by a functional group having a plurality of phosphonic acid groups as disclosed in, for example, PCT Japanese Translation Patent Publication No. 2009-515007. Furthermore, a specific example thereof is a self-dispersing pigment in which the surface of each of the particles of the pigment is modified by —COOM serving as a hydrophilic group as disclosed in, for example, Japanese Patent Laid-Open No. 2006-89735.

The average particle size of the self-dispersion pigment contained in the ink for ink jet recording according to aspects of the present invention is determined in a liquid by dynamic light scattering and is preferably 60 nm or more, more preferably 70 nm or more, and still more preferably 75 nm or more. Furthermore, the average particle size is preferably 145 nm or less, more preferably 140 nm or less, and still more preferably 130 nm or less. The term “average particle size” defined here indicates a scattering average particle size. Regarding a specific method for measuring the average particle size, the average particle size can be measured with, for example, FPAR-1000 (manufactured by Otsuka Electronics Co., Ltd., analysis by a cumulant method) or Nanotrac UPA 150EX (manufactured by NIKKISO CO., LTD., as a 50% cumulative value) using the scattering of laser light. Examples of the self-dispersing pigment include a self-dispersing pigment available as COJ (trade name, manufactured by Cabot Corporation) and CW (trade name, manufactured by Orient Chemical Industries Co., Ltd).

Two or more self-dispersing pigments may be used in combination in the same ink as needed. Ink has a self-dispersing pigment content of preferably 0.5% by mass or more, more preferably 1.0% by mass or more, and still more preferably 2.0% by mass or more, and preferably 15.0% by mass or less, more preferably 10.0% by mass or less, and still more preferably 8.0% by mass or less with respect to the total amount of the ink.

An ink set used in the formation of a color image with inks of a plurality of colors basically includes black, cyan, magenta, and yellow inks. Red, blue, green, gray, ligh cyan, and light magenta inks may be added as needed. Coloring materials contained in these inks can also be self-dispersion pigments.

### Polymer Particles

The ink for ink jet recording according to aspects of the present invention contains polymer particles. The polymer particles contained in the ink for ink jet recording according to aspects of the present invention have a glass transition temperature of 25 degrees (Celsius) or lower, an average particle size of 80 nm to 220 nm, and an acid value of 25 mgKOH/g to 150 mgKOH/g. The polymer particles can be composed of one or two or more polymers selected from the group consisting of acrylic polymers, methacrylic polymers, styrene polymers, urethane polymers, acrylamide polymers, epoxy polymers, ester polymers. These polymers can be used as copolymers and may have a single-phase structure or a multiphase structure (core-shell structure).

With respect to the polymer particles contained in the ink for ink jet recording according to aspects of the present invention, the polymer particles can be incorporated into an ink composition in the form of an emulsion of the polymer particles prepared by emulsion polymerization or soap-free emulsion polymerization. An example of the emulsion is an acrylic emulsion. This is because when dry polymer particles are added to an ink composition, the polymer particles are not sufficiently dispersed, in some cases. Furthermore, an emulsion prepared by polymerizing a vinyl monomer can be used in view of the storage stability of the ink composition. The emulsion of the polymer particles can be prepared by a known emulsion polymerization method. For example, the emulsion of the polymer particles may be prepared by a method in which a hydrophobic monomer, e.g., styrene, a(alpha)-methylstyrene, or methyl methacrylate, and a hydrophilic monomer, e.g., styrenesulfonic acid, vinyltoluenesulfonic acid, 2-acrylamido-2-methylpropanesulfonic acid, acrylic acid, methacrylic acid, itaconic acid, fumaric acid, acrylonitrile, acrylamide, 4-vinylpyridine, N,N-dimethylaminoethyl methacrylate, or N,N-dimethylaminoethyl methacrylate monoester of maleic acid are subjected to soap-free emulsion polymerization using potassium persulfate serving as an initiator.

In addition, the emulsion of the polymer particles can be prepared by emulsion polymerization of a monomer in water in the presence of a polymerization initiator and a surfactant. While typical monomers are exemplified below, monomers that can be used in the present invention are not limited thereto. Examples of carboxylic acid monomers include acrylic acid, methacrylic acid, itaconic acid, fumaric acid, and maleic acid. Examples of sulfonic acid monomers include 3-sulfopropyl (meth)acrylate, vinylstyrenesulfonic acid, and 2-acrylamido-2-methylpropanesulfonic acid. Examples of acrylic ester monomers include acrylic esters, such as methyl acrylate, ethyl acrylate, isopropyl acrylate, n-butyl acrylate, isobutyl acrylate, n-amyl acrylate, isoamyl acrylate, n-hexyl acrylate, 2-ethylhexyl acrylate, octyl acrylate, decyl acrylate, dodecyl acrylate, octadecyl acrylate, cyclohexyl acrylate, phenyl acrylate, benzyl acrylate, glycidyl acrylate, phenoxyethyl acrylate, and 2-hydroxyethyl acrylate. Examples of methacrylic ester monomers include methyl methacrylate, ethyl methacrylate, isopropyl methacrylate, n-butyl methacrylate, isobutyl methacrylate, n-amyl methacrylate, isoamyl methacrylate, n-hexyl methacrylate, 2-ethylhexyl methacrylate, octyl methacrylate, decyl methacrylate, dodecyl methacrylate, octadecyl methacrylate, cyclohexyl methacrylate, phenyl methacrylate, benzyl methacrylate, glycidyl methacrylate, phenoxyethyl methacrylate, 2-hydroxyethyl methacrylate, polyethylene glycol monomethacrylate, and polypropylene glycol methacrylate. Examples of a crosslinkable monomer having two or more polymerizable double bonds include diacrylate compounds, such as polyethylene glycol diacrylate, triethylene glycol diacrylate, 1,3-butylene glycol diacrylate, 1,4-butylene glycol diacrylate, 1,6-hexanediol diacrylate, neopentyl glycol diacrylate, 1,9-nonanediol diacrylate, polypropylene glycol diacrylate, 2,2′-bis(4-acryloxypropoxyphenyl)propane, 2,2′-bis(4-acryloxydiethoxyphenyl)propane, and N,N′-methylenebisacrylamide; triacrylate compounds, such as trimethylolpropane triacrylate, trimethylolethane triacrylate, and tetramethylolmethane triacrylate; tetraacrylate compounds, such as ditrimethylol tetraacrylate, tetramethylolmethane tetraacrylate, and pentaerythritol tetraacrylate; hexaacrylate compounds, such as dipentaerythritol hexaacrylate; dimethacrylate compounds, such as ethylene glycol dimethacrylate, diethylene glycol dimethacrylate, triethylene glycol dimethacrylate, polyethylene glycol dimethacrylate, 1,3-butylene glycol dimethacrylate, 1,4-butylene glycol dimethacrylate, 1,6-hexanediol dimethacrylate, neopentyl glycol dimethacrylate, dipropylene glycol dimethacrylate, polypropylene glycol dimethacrylate, polybutylene glycol dimethacrylate, and 2,2′-bis(4-methacryloxydiethoxyphenyl)propane; trimethacrylate compounds, such as trimethylolpropane trimethacrylate and trimethylolethane trimethacrylate; methylenebisacrylamide; and divinylbenzene.

While examples of monomers that are copolymerizable with the foregoing monomers are described below, copolymerizable monomers that can be used in the present invention are not limited thereto. Examples thereof include aromatic vinyl monomers, such as styrene, a(alpha)-methylstyrene, vinyltoluene, 4-tert-butylstyrene, chlorostyrene, vinylanisole, and vinylnaphthalene; olefins, such as ethylene and propylene; dienes, such as butadiene and chloroprene; vinyl monomers, such as vinyl ether, vinyl ketone, and vinylpyrrolidone; acrylamides, such as acrylamide, methacrylamide, and N,N′-dimethylacrylamide; and hydroxyl group-containing monomers, such as 2-hydroxyethyl acrylate, 2-hydroxypropyl acrylate, 2-hydroxyethyl methacrylate, and 2-hydroxypropyl methacrylate.

An exemplary method for producing polymer particles from the foregoing exemplified monomer will be described below.

### Exemplary Production of Polymer Particles

A predetermined amount of a monomer and 100 g of distilled water serving as a solvent are charged into a 300-mL four-neck flask equipped with a stirrer bearing, a stirrer rod, a reflux condenser, a rubber septum, and a nitrogen inlet tube. The resulting mixture is stirred at 300 rpm in a constant temperature bath having a temperature of 70 degrees (Celsius) under a nitrogen purge for 1 hour. Then an initiator dissolved in 100 g of distilled water is injected into the flask using a syringe to initiate polymerization. The polymerization is monitored by gel permeation chromatography and NMR to a desired polymerization product. The formed polymer particles are repeatedly subjected to the steps of centrifugation and redispersion, thereby purifying the polymer particles in the form of an aqueous dispersion. The purified polymer particles are concentrated, as needed, with an evaporator, ultrafiltration, or the like.

A polymerization initiator the same as a common polymerization initiator used in radical polymerization may be used as the polymerization initiator. Examples thereof include potassium persulfate and 2,2′-azobis(2-amidinopropane) dihydrochloride. In addition to the polymerization initiator, a surfactant, a chain transfer agent, a neutralizer, and so forth may be used in the usual manner. In particular, ammonia or a hydroxide of an inorganic alkali, e.g., sodium hydroxide or potassium hydroxide, can be used as the neutralizer. Examples of an emulsifier include sodium lauryl sulfate; and compounds commonly used as anionic surfactants, nonionic surfactants, and amphoteric surfactants. Examples of a chain transfer agent used in a polymerization reaction include tert-dodecyl mercaptan, n-dodecyl mercaptan, n-octyl mercaptan, xanthogens, such as dimethylxanthogen disulfide and diisobutylxanthogen disulfide, dipentene, indene, 1,4-cyclohexadiene, dihydrofuran, and xanthene.

The polymer particles according to aspects of the present invention have a glass transition temperature of 25 degrees (Celsius) or lower. The mean temperature of an indoor environment is assumed to be 25 degrees (Celsius). It is known that when the aqueous dispersion of the polymer particles having a glass transition temperature of 25 degrees (Celsius) or lower is dried at room temperature, a continuous film is easily formed. The self-dispersing pigment is bonded to a recording medium by the film formation of the polymer particles, thus improving the water-fastness of a recorded image and the fixity such as highlighter resistance. In particular, the film formation of the polymer particles is effective under more severe conditions, i.e., in marking (scratching) with a highlighter at a high writing pressure, and in marking with a highlighter and scratching and so forth immediately after printing. A glass transition temperature exceeding 25 degrees (Celsius) does not result in the film formation during drying, in some cases, as described above. The polymer particles more preferably have a glass transition temperature of 15 degrees (Celsius) or lower and preferably −60 degrees (Celsius) or higher. A glass transition temperature of the polymer particles of lower than −60 degrees (Celsius) can lead to the formation of a film with low strength. The polymer particles more preferably have a glass transition temperature of −50 degrees (Celsius) or higher. In aspects of the present invention, the glass transition temperature (Tg) is defined as a value measured by a common method, for example, using a thermal analyzer such as differential scanning calorimeter (DSC).

The polymer particles according to aspects of the present invention have an average particle size of 80 nm to 220 nm. The average particle size is preferably 100 nm or more, more preferably 120 nm or more, and still more preferably 130 nm or more, and preferably 210 nm or less and more preferably 200 nm or less. In a thermal ink jet recording method, an excessively small average particle size of the polymer particles of less than 80 nm is liable to cause unstable ejection, depending on the foregoing glass transition temperature of the polymer particles. A large average particle size exceeding 220 nm can result in polymer particles with low dispersion stability, low storage stability, and low highlighter resistance. Regarding a specific method for measuring the average particle size, the average particle size can be measured with, for example, FPAR-1000 (manufactured by Otsuka Electronics Co., Ltd., analysis by a cumulant method) or Nanotrac UPA 150EX (manufactured by NIKKISO CO., LTD., using a 50% cumulative value of a volume-weighted mean diameter) using the scattering of laser light. The average particle size of the polymer particles according to aspects of the present invention indicates a scattering average particle size.

The polymer particles according to aspects of the present invention have an acid value of 25 mgKOH/g to 150 mgKOH/g. The acid value is more preferably 140 mgKOH/g or less. The acid value indicates the amount of KOH (mg) required to neutralize 1 g of a polymer. An acid value exceeding 150 mgKOH/g is liable to cause an increase in the viscosity of a dispersion to be formed, thereby leading to unstable ejection. An acid value of less than 25 mgKOH/g is liable to result in ink with low storage stability. Note that the acid value can be determined by calculation from the composition of monomers constituting the polymer particles. Regarding a specific method for measuring an acid value, the acid value is determined by potentiometric titration with, for example, Titrino (trade name, manufactured by Metrohm AG).

The weight-average molecular weight (Mw) of the polymer particles according to aspects of the present invention is preferably in the range of, but not particularly limited to, 50,000 to 50,000,000 from the viewpoint of achieving ejection stability and highlighter resistance. The weight-average molecular weight is more preferably 100,000 or more and still more preferably 200,000 or more, and more preferably 25,000,000 or less and still more preferably 10,000,000. A weight-average molecular weight of the polymer particles of less than 50,000 can result in the polymer particles with insufficiently improved highlighter resistance. A weight-average molecular weight exceeding 50,000,000 can impair ejection stability in an ink jet recording method including ejecting and flying ink droplets by the action of thermal energy to perform recording. Note that the weight-average molecular weight used in aspects of the present invention is a value measured by gel permeation chromatography (GPC) that uses the excluded volume of the molecules as a separation principle.

According to aspects of the present invention, as described above, when the glass transition temperature, the average particle size, and the acid value of the polymer particles are within the ranges of the present invention, it is possible to significantly improve the fixity such as highlighter resistance of a recorded image, the dispersion stability of the ink, and ejection properties in the thermal ink jet recording method. This is because the glass transition temperature, the average particle size, and the acid value of the polymer particles contribute synergistically to the fixity such as highlighter resistance of a recorded image, the dispersion stability of the ink, and ejection properties in the thermal ink jet recording method.

The film formability of the polymer particles contributes significantly to the manifestation of the highlighter resistance, as described above. In the case where the polymer particles are used and where a continuous film is formed and dried at room temperature, the glass transition temperature of the polymer particles needs to be the room temperature or lower. Thus, when the glass transition temperature of the polymer particles is within the range of the present invention, the highlighter resistance is suitably manifested. A low glass transition temperature of the polymer particles can impair the dispersion stability of the polymer particles in the ink and can degrade ejection properties in the thermal ink jet recording method. With respect to the degradation of the e ection properties in the thermal ink jet recording method due to the low glass transition temperature of the polymer particles, the inventors have found that the ejection properties are improved by setting the average particle size of the polymer particles to a certain size or more and by setting the acid value within a suitable range. Furthermore, the inventors have found that an increase in the average particle size of the polymer particles allows the polymer particles to be easily left on a surface layer of a recording medium such as plain paper, thereby more effectively providing the binder function.

However, simply increasing the average particle size of the polymer particles is not good. An excessively large average particle size can impair the dispersion stability. Furthermore, the highlighter resistance is not sufficiently improved, in some cases, possibly because the polymer particles having an excessively large average particle size has an adverse effect on the film formation during drying. The inventors have found that as one requirement to overcome the plural problems, when the average particle size of the polymer particles is within the range of the present invention, the foregoing plural problems can be suitably solved.

Similarly, the acid value of the polymer particles contributes to the plural problems. An excessively low acid value can impair the dispersion stability of a dispersion of the polymer particles. In particular, the ejection properties in the thermal ink jet recording method can be degraded. At an excessively high acid value, although the dispersion stability of the dispersion of the polymer particles is satisfactory, the viscosity of the dispersion can be increased, thereby degrading the ejection properties. The inventors have found that as one requirement to overcome the plural problems, when the acid value of the polymer particles is within the range of the present invention, the foregoing plural problems can be suitably solved. Furthermore, the inventors have found that in the case where the polymer particles have an acid value within the range of the present invention, ionic functional groups and counterions of the polymer particles produce ion clusters during the film formation to form a stronger film, thereby more effectively providing the scratch resistance and the highlighter resistance.

As described above, the inventors have found that the glass transition temperature, the average particle size, and the acid value of the polymer particles interact with the fixity such as highlighter resistance of a recorded image, the dispersion stability of the ink, and the ejection properties in the thermal ink jet recording method and have found optimal ranges of values therefor.

For the polymer particles according to aspects of the present invention, the polymer particles in a dry state may be mixed with other components of an ink composition. In view of the dispersion stability of the polymer particles described above, after the polymer particles are dispersed in an aqueous medium to form an emulsion (polymer emulsion), the resulting emulsion can be mixed with other components of the ink composition.

The ink for ink jet recording according to aspects of the present invention has a polymer particle content of preferably 0.1% by mass or more and more preferably 0.5% by mass or more, and preferably 20.0% by mass or less and more preferably 10.0% by mass. A polymer particle content of less than 0.1% by mass is liable to inhibit the manifestation of the highlighter resistance. A polymer particle content exceeding 20.0% by mass is liable to cause the ink to have an excessively high viscosity.

### Salt

The ink for ink jet recording according to aspects of the present invention can contain an inorganic acid salt and/or an organic acid salt. When the organic acid salt or inorganic acid salt is contained therein, the effects of the present invention of the present invention can be further enhanced. Specifically, the image density, the water-fastness, and the highlighter resistance are improved. In addition, when small characters are printed, the quality of the characters is also improved. The reason for this may be as follows: When the ink containing an organic acid salt or inorganic acid salt is landed on a recording medium, the organic acid salt or inorganic acid salt facilitates the deposition of the pigment and the polymer particles, i.e., facilitates the solid-liquid separation of the pigment, the polymer particles, and the aqueous medium. This makes it possible to selectively fix the pigment and the polymer particles to a surface layer of a recording medium, thus effectively bonding the polymer particles to the pigment, which contributes effectively to not only high color developability in a recording image but also the manifestation of water-fastness and highlighter resistance. Furthermore, the time from the landing of the ink on the recording medium to the fixation is reduced, thus suppressing spreading and contributing to improvement in the quality of characters when small characters are printed. To provide these effects, the inorganic acid salt or organic acid salt can be dissociated in the ink. Thus, the inorganic acid salt or organic acid salt added can have a lower acid dissociation constant (pKa) than the pH of the ink.

Examples of an inorganic acid that can form the inorganic acid salt include hydrochloric acid, sulfuric acid, and nitric acid. Examples of an organic acid that can form the organic acid salt include organic carboxylic acids, such as citric acid, succinic acid, benzoic acid, acetic acid, propionic acid, phthalic acid, oxalic acid, tartaric acid, gluconic acid, tartronic acid, maleic acid, malonic acid, and adipic acid. Among these compounds, acetic acid, phthalic acid, benzoic acid, and so forth can be used. Similarly to the counterions of the self-dispersing pigment, examples of counterions that form the salts include alkali metals, ammonium, and organic ammonium. Specific examples of alkali metals serving as the counterions include Li, Na, K, Rb, and Cs. Specific examples of organic ammonium include methylammonium, dimethylammonium, trimethylammonium, ethylammonium, diethylammonium, triethylammonium, monohydroxymethyl(ethyl)ammonium, dihydroxymethyl(ethyl)ammonium, trihydroxymethyl(ethyl)ammonium, and triethanolammonium.

The total proportion of the inorganic acid salt and/or the organic acid salt in the ink for ink jet recording according to aspects of the present invention is preferably in the range of 0.1% by mass to 5.0% by mass. More preferably, the total proportion is 0.2% by mass or more and 3.0% by mass or less. A total proportion of less than 0.1% by mass can cause a reduction in the effect of depositing the pigment and the polymer particles after the landing of the ink. A total proportion exceeding 5.0% by mass can cause solid-liquid separation in the ink to reduce the dispersion stability of the ink.

### Aqueous Medium

The ink for ink jet recording according to aspects of the present invention contains water. The ink can have a water content of 30% by mass to 95% by mass with respect to the total amount of the ink. Furthermore, a water-soluble compound can be added to water to form an aqueous medium. The water-soluble compound has high hydrophilicity and is miscible with water in a concentration of 20% by mass without phase separation. Furthermore, it is difficult to use an easily evaporable water-soluble compound from the viewpoint of solid-liquid separation and the prevention of clogging. A compound having a vapor pressure of 0.04 mmHg or less at 20 degrees (Celsius) can be used.

The ink for ink jet recording according to aspects of the present invention can contain a water-soluble compound having a coefficient of hydrophilicity-hydrophobicity of 0.26 or more, the coefficient of hydrophilicity-hydrophobicity being defined by Equation (A). An ink containing a water-soluble compound having a coefficient of hydrophilicity-hydrophobicity of 0.26 or more and less than 0.37 and a water-soluble compound having a coefficient of hydrophilicity-hydrophobicity of 0.37 or more can be used, depending on the type of paper. In this case, an ink containing two or more types of water-soluble compounds each having a coefficient of hydrophilicity-hydrophobicity of 0.37 or more can also be used.

$$\begin{matrix}[ Math . 1 ] & \\ Coefficient of hydrophilicity - hydrophobicity = \frac{( \begin{matrix}water activity value \\ of 20 \% aqueous solution\end{matrix} ) - ( \begin{matrix}mole fraction of water \\ in 20 \% aqueous solution\end{matrix} )}{1 - ( \begin{matrix}mole fraction of water in \\ 20 \% aqueous solution\end{matrix} )} & Equation ( A )\end{matrix}$$

The water activity value in the equation is represented by the expression:

Water activity value=(water vapor pressure of the aqueous solution)/(water vapor pressure of pure water).

Various methods are available as methods for measuring the water activity value.

The water activity value may be measured by various methods. Any of the various methods may be employed. Among these methods, a chilled mirror dew-point measurement method can be employed for the measurement of materials used in aspects of the present invention. Values of the described in this specification are obtained by measuring 20% aqueous solutions of the water-soluble compounds by the measurement method with AquaLab CX-3TE (manufactured by Decagon Devices, Inc.) at 25 degrees (Celsius).

According to the Raoult's Law, a rate of vapor pressure depression of a dilute solution is equal to a molar fraction of a solute and has no connection with the kinds of the solvent and the solute, so that the molar fraction of water in an aqueous solution is equal to the water activity value. However, in the case where water activity values of aqueous solutions of various water-soluble compounds are measured, the water activity values do not often match the molar fraction of water. In the case where the water activity value of an aqueous solution is lower than the molar fraction of water, the water vapor pressure of the aqueous solution is smaller than a theoretical calculated value, and evaporation of water is inhibited by the presence of a solute. This demonstrates that the solute is a substance with a large hydration force. In the case where the water activity value of an aqueous solution is higher than the molar fraction of water, the solute is a substance with a small hydration force.

The inventors have focused on the fact that the degree of hydrophilicity or hydrophobicity of a water-soluble compound contained in the ink greatly affects the promotion of solid-liquid separation between a self-dispersion pigment and an aqueous medium, and various ink performances. Thus, the inventors have defined the co-efficient of hydrophilicity-hydrophobicity represented by Equation (A). The water activity values of aqueous solutions of various water-soluble compounds are measured, the aqueous solutions having a fixed concentration of 20% by mass. The conversion of the water activity value by Equation (A) permits relative comparisons of the degrees of hydrophilicity or hydrophobicity between various solutes even when the molecular weights of the solutes and the molar fractions of water are different. Since the water activity value of an aqueous solution does not exceed one, the maximum value of the coefficient of hydrophilicity-hydrophobicity is one. Table 1 shows the coefficients of hydrophilicity-hydrophobicity, which are obtained from Equation (A), of water-soluble compounds used in inks for ink jet recording. However, the water-soluble compounds according to aspects of the present invention are not limited only to these compounds.

TABLE 1

| | Coefficient of |
|---|---|
| Substance name | hydrophilicity-hydrophobicity |
| 1,2-Hexanediol | 0.97 |
| 1,2-Pentanediol | 0.93 |
| 3-Methyl-1,3-butanediol | 0.90 |
| 1,2-Butanediol | 0.90 |
| 2,4-Pentanediol | 0.88 |
| 1,6-Hexanediol | 0.76 |
| 1,7-Heptanediol | 0.73 |
| 3-Methyl-1,5-pentanediol | 0.54 |
| 1,5-Pentanediol | 0.41 |
| Trimethylolpropane | 0.31 |
| Ethylene urea | 0.30 |
| 1,2,6-Hexanetriol | 0.28 |
| 1,2,3-Butanetriol | 0.22 |
| Sorbitol | 0.21 |
| Urea | 0.20 |
| Diethylene glycol | 0.15 |
| 1,2,4-Butanetriol | 0.15 |
| Glycerol | 0.11 |
| Diglycerol | 0.08 |
| Triethylene glycol | 0.07 |
| Polyethylene glycol 200 | −0.09 |
| Polyethylene glycol 600 | −0.43 |

Water-soluble compounds having an intended coefficient of hydrophilicity-hydrophobicity can be selected from various kinds of water-soluble compounds that are suitable for use in inks for ink jet recording. The inventors have conducted studies on the relationship between water-soluble compounds different in the coefficient of hydrophilicity-hydrophobicity and the performance of various inks containing the water-soluble compounds. The following findings have thus been obtained. In the case of an ink containing the self-dispersing pigment and either inorganic acid salt and/or organic acid salt that can be used in aspects of the present invention, the use of a low hydrophilic water-soluble compound having a coefficient of hydrophilicity-hydrophobicity of 0.26 or more resulted in extreme improvement in printing characteristics, e.g., bleeding between two colors and dot gain, of small characters. Among such water-soluble compounds, compounds each having a glycol structure in which the number of carbon atoms unsubstituted with a hydrophilic group is larger than the number of carbon atoms substituted with a hydrophilic group can be used. These water-soluble compounds have relatively low affinities for water, the self-dispersing pigment, and cellulose fibers and thus function to strongly promote the solid-liquid separation between the self-dispersing pigment and water after the landing of the ink on paper. Thus, the ink for ink jet recording according to aspects of the present invention can contain at least one water-soluble compound having a coefficient of hydrophilicity-hydrophobicity, which is defined by Equation (A), of 0.26 or more. As a water-soluble compound having a coefficient of hydrophilicity-hydrophobicity, which is defined by Equation (A), of 0.26 or more and less than 0.37, trimethylolpropane can be used. As a water-soluble compound having a coefficient of hydrophilicity-hydrophobicity of 0.37 or more, compounds each having a glycol structure and 4 to 7 carbon atoms can be used. Among these compounds, 1,2-hexanediol and 1,6-hexanediol can be used. In the case where two or more of the water-soluble compounds each having a coefficient of hydrophilicity-hydrophobicity of 0.37 or more are used, a difference in terms of the coefficient of hydrophilicity-hydrophobicity therebetween may be 0.1 or more.

The total proportion of the water-soluble compound in the ink is preferably 5.0% by mass or more, more preferably 6.0% by mass or more, and still more preferably 7.0% by mass or more, and preferably 40.0% by mass or less, more preferably 35.0% by mass or less, and still more preferably 30.0% by mass or less.

### Surfactant

The ink for ink jet recording according to aspects of the present invention can contain a surfactant for achieving the ejection stability with a good balance. In particular, the ink can contain a nonionic surfactant. Among nonionic surfactants, polyoxyethylene alkyl ethers and ethylene oxide adducts of acetylene glycol can be used. Each of the nonionic surfactants has a hydrophile-lipophile balance (HLB) of 10 or more. The proportion of the surfactant contained in the ink is preferably 0.1% by mass or more, more preferably 0.2% by mass or more, and still more preferably 0.3% by mass or more, and preferably 5.0% by mass or less, more preferably 4.0% by mass or less, and still more preferably 3.0% by mass or less.

### Additional Additive

To achieve desired physical properties, the ink for ink jet recording according to aspects of the present invention may contain an additive, for example, a pH adjusting agent, a viscosity modifier, an antifoaming agent, a preservative, an anti-mold agent, an antioxidant, or an penetrant, as needed, in addition to the foregoing components.

### Surface Tension

The ink for ink jet recording according to aspects of the present invention preferably has a surface tension of 34 mN/m or less, more preferably 32 mN/m or less, and still more preferably 30 mN/m or less. Glossy paper and mat paper, which are specialized ink jet paper, each have a porous ink-receiving layer formed on a surface of paper unlike plain paper; hence, such paper is negligibly affected by the surface tension of the ink, so that the ink penetrates rapidly thereinto. However, a sizing agent having a water-repellent effect is internally and/or externally added to plain paper and printing paper, thus often inhibiting the penetration of an ink. That is, plain paper and printing paper each have a lower critical surface tension, which is an index as to whether a surface can be rapidly wetted with ink or not, than that of specialized ink jet paper. When the surface tension of the ink is larger than 34 mN/m, which is higher than the critical surface tension of paper, plain paper is not immediately wetted after the landing of the ink, so that the ink does not penetrate rapidly, in some cases. Furthermore, in the case of an ink having a high surface tension, even if the contact angle between the ink and the paper is reduced by somewhat improving the wettability of the ink with paper, the ink is not rapidly fixed, thus reducing the fixity, in some cases. In the case of the ink having a surface tension of 34 mN/m or less, the ink is mainly absorbed in a pore absorption mode. In the case of the ink having a surface tension exceeding 34 mN/m, the ink is mainly absorbed in a fiber absorption mode. A comparison between the two absorption modes demonstrates that the speed of the pore absorption is significantly faster than that of the fiber absorption when an ink is absorbed in paper. Accordingly, aspects of the present invention can provide an ink to be mainly absorbed in the pore absorption mode, achieving high-speed fixing. The ink to be mainly absorbed in the pore absorption mode has the advantage that bleeding is inhibited when two inks of different colors are applied to adjoining portions. This is because the two inks are inhibited from being simultaneously present on a surface of paper. From another viewpoint of achieving good handleability of the ink, the ink according to aspects of the present invention preferably has a surface tension of 20 mN/m or more, preferably 23 mN/m or more, and still more preferably 26 mN/m or more. At a surface tension of 20 mN/m or more, a meniscus can be retained in a nozzle. This makes it possible to inhibit “ink falling” in which the ink comes out of an ejection orifice and escapes from the nozzle. Note that the values of the surface tension were measured by a vertical flat plate method. A specific example of a measurement device is CBVP-Z (trade name, manufactured by Kyowa Interface Science Co., Ltd).

### Thermal Ink jet Recording Method

A thermal ink jet recording method using the ink for ink jet recording according to aspects of the present invention will be described below. In the recording method according to aspects of the present invention, the amount of an ink droplet applied at one time can be set to a fixed amount of 0.5 pl to 6.0 pl. The amount of an ink droplet applied at one time is set to preferably 1.0 pl or more and more preferably 1.5 pl or more, and preferably 5.0 pl or less and more preferably 4.5 pl or less. An amount of less than 0.5 pl is susceptible to airflow and can cause a reduction in the accuracy of the landing position of the ink droplet. At an amount exceeding 6.0 pl, when small characters each having a font size of about 2 points (1 point: approximately equal to 0.35 mm) to 5 points are printed, the characters can be illegible by dot gain. The volume of the ink ejected greatly affects the strike-through of the ink and is thus important in the application to duplex printing. In general, plain paper and some printing paper, in particular, uncoated printing paper, each have a pore-size distribution ranging from 0.1 micrometers to 100 micrometers and mainly ranging from 0.5 micrometers to 5.0 micrometers. The term “plain paper” used in aspects of the present invention indicates copying paper, such as commercially available wood free paper, medium grade paper and PPC paper, and bond paper, which are used in a large amount in printers, copying machines, and so forth. The penetration phenomenon of an aqueous ink into the plain paper is roughly categorized into fiber absorption, in which the ink penetrates into the paper by being directly absorbed by cellulose fibers of the plain paper, and pore absorption, in which the ink penetrates into the paper by being absorbed by pores formed between the cellulose fibers. The ink according to aspects of the present invention can be mainly absorbed in the pore absorption mode. Thus, in the case where the ink according to aspects of the present invention is applied to the plain paper and a portion of the ink comes into contact with largish pores each having a size of about 10 micrometers or more, which are present on a surface of the plain paper, the ink is concentrated on the largish pores according to the Lucas-Washburn equation and absorbed and permeated therein. Thus, the ink penetrates particularly deeply in this portion, which is extremely disadvantageous in achieving high color development on the plain paper. Meanwhile, a smaller ink droplet results in a reduction in the probability that the ink droplet comes into contact with the largish pore. Thus, the ink is less likely to be concentrated on and absorbed in the largish pore. Furthermore, even if the ink droplet comes into contact with the largish pore, the amount of the ink that penetrates deeply thereinto may be small as long as the ink droplet is small. As a result, an image with high color development is obtained on the plain paper. The phrase “fixed amount of the ink” used in aspects of the present invention indicates an ink ejected in a state in which all nozzles included in a recording head have an identical structure and in which a fixed amount of drive energy is applied. In other words, in such a state, the amount of the ink applied is fixed even if ejection is somewhat varied because of an error in producing an apparatus. A fixed amount of the ink applied results in the stabilization of the penetration depth of the ink, a recorded image with a high image density, and satisfactory uniformity of the image. In contrast, according to a system based on the premise that the amount of the ink applied is varied, the amount of the ink is not fixed. The presence of ink droplets different in volume increases the variations of the penetration depth of the ink. In particular, a high-density region of a recorded image has a portion with a low image density because of the variations of the penetration depth, reducing the uniformity of the image. The thermal ink jet recording method is suitable for applying an ink in a fixed amount. This method makes it possible to suppress the variations of the penetration depth of the ink and to yield a recorded image having a high image density and satisfactory uniformity. Furthermore, the thermal ink jet recording method is suitable for achieving a recording head having a larger number of nozzles and higher density and also suitable for high-speed recording.

A recording method using the ink for ink jet recording according to aspects of the present invention tends to provide the advantages when an image having a portion with a duty of 80% or more is formed in a basic matrix configured to form an image. A portion for calculating the duty is 50 micrometers×50 micrometers at the minimum The image having a portion with a duty of 80% or more is an image having a portion formed by the application of the ink to 80% or more of cells in the matrix of the portion for calculating the duty. The size of the cell is determined by the resolution of the basic matrix. For example, in the case where the basic matrix has a resolution of 1200 dpi×1200 dpi, the size of one cell is 1/1200 inch× 1/1200 inch. The image having the portion with a duty of 80% or more in the basic matrix is an image having a portion where one color ink is applied in a duty of 80% or more in the basic matrix. That is, in the case where four color inks of black, cyan, magenta, and yellow are used, the image having the portion with a duty of 80% or more in the basic matrix is an image having a portion where at least one color ink thereof is applied in a duty of 80% or more in the basic matrix. Meanwhile, an image having no portion with a duty of 80% or more in the basic matrix has only a relatively small overlapping between landed ink droplets and may not cause problems of the illegibility of characters and bleeding even when the printing process is not devised, in many cases. The basic matrix according to aspects of the present invention can be freely set according to the recording apparatus or the like. The resolution of the basic matrix is preferably 600 dpi or more and more preferably 1200 dpi or more, and preferably 4800 dpi or less. The resolution may be the same or different in length and width as long as it falls within this range.

The recording method using the ink for ink jet recording according to aspects of the present invention tends to provide the advantages when an image having a portion where the total amount of the ink applied is 5.0 microliters per square centimeter or less is formed in a basic matrix configured to form an image.

In aspects of the present invention, the application of the ink can be divided into two or more times when an image having a portion where the duty is 80% or more and the total amount of the ink applied is 5.0 microliters per square centimeter or less is formed in the basic matrix configured to form the image. The amount of the ink applied at each of the times divided is 0.7 microliters per square centimeter or less, preferably 0.6 microliters per square centimeter or less, and more preferably 0.5 microliters per square centimeter or less. If the amount of the ink applied to the image at each time exceeds 0.7 microliters per square centimeter, the strike-through, the illegibility of characters, and bleeding can occur.

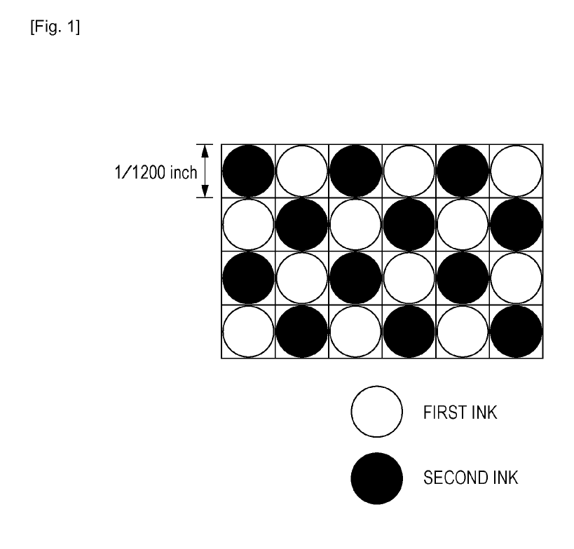

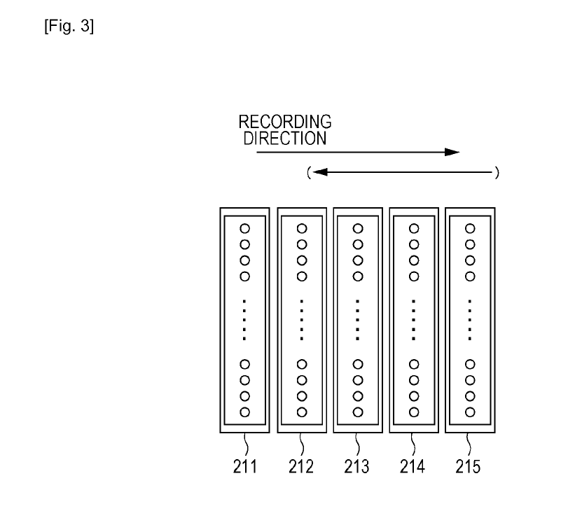

The reason the application of the ink divided into the plural times in the formation of the image can be performed is based on the fact that there is a particular difference in performance between divided application and undivided application. The number of times of division of the ink application is at least two times or more. When the number of times of division is three times or more, the resulting recorded image has a higher density and good color developability. The number of times is preferably eight times or less and more preferably four times or less. If the number of times of division exceeds eight times, there is a tendency that the covering rate of the ink on the surface of plain paper is lowered to degrade color developability though such application is effective for inhibition of bleeding and good printing of small characters. A method for dividing the application of the ink into two or more times is broadly categorized into a serial mode and a line mode. Suppose a serial printer is taken as an example, for example, in the case where solid printing is performed in two times, a recording head passes through a recording medium two times (two passes). In many cases, for divisional application, an equal amount of the ink is applied each time. However, the present invention is not limited thereto. For two-pass printing, FIG. 1 shows an exemplary arrangement of dot landing positions when 100% solid printing is performed by applying 50% of the amount of the ink to the recording medium on the first pass and then applying 50% of the amount of the ink to the remaining portions of the recording medium on the second pass. In addition to the method for dividing the application of the ink in the serial mode, in aspects of the present invention, the line mode may be used in which two-divided applications of dots to positions the same as the positions illustrated in FIG. 1 is performed in one pass. According to an embodiment, an exemplary recording head having a structure configured to perform two-divided applications of a black ink in one pass is illustrated in FIG. 3. In this embodiment, regarding an exemplary head structure for color inks, reference numerals 211, 212, 213, 214, and 215 denote black (K), cyan (C), magenta (M), yellow (Y), and black (K) inks, respectively. In the head structure according to this embodiment, the black ink is arranged in the two nozzle rows, and the black ink is substantially applied in one pass. Similarly, by changing the number of nozzle rows and the number of inks mounted on the head, various inks can be applied in substantially one pass, the application of each ink being divided into two or more times. In one head, when the time from the start of the application of an ink to the completion of the application of the same ink is set to 1 msec or more and less than 200 msec, the effect of the ink for ink jet recording according to aspects of the present invention can be more effectively provided.

### Thermal Ink jet Recording Apparatus

A thermal ink jet recording apparatus using the ink for ink jet recording according to aspects of the present invention will be described below. A recording apparatus for use in aspects of the present invention is an apparatus including a recording head configured to apply an ink by the action of thermal energy.

With respect to the typical structure and the principle of the recording head that applies an ink by the action of thermal energy, those using the basic principle disclosed in, for example, U.S. Pat. Nos. 4,723,129 and 4,740,796 can be used. This system may be applied to any of the so-called on-demand type and continuous type. Among these types, the on-demand type is more advantageous. That is, for the on-demand type, at least one driving signal, which corresponds to recording information and gives a rapid temperature rise exceeding nuclear boiling, is applied to an electrothermal converter arranged corresponding to a sheet or a liquid path, in which an ink is retained. This application allows the electrothermal converter to generate thermal energy to cause film boiling on the heat-acting surface of a recording head, so that a bubble can be formed in the ink in response to the driving signal in relation of one to one. The ink is ejected through an ejection opening by the growth-contraction of this bubble to form at least one droplet. When the driving signal is applied in the form of a pulse, the growth-contraction of the bubble properly occurs in a moment. As a result, the amount of the ink ejected is fixed, and the ejection of the ink, which is also excellent in responsiveness, can be achieved.

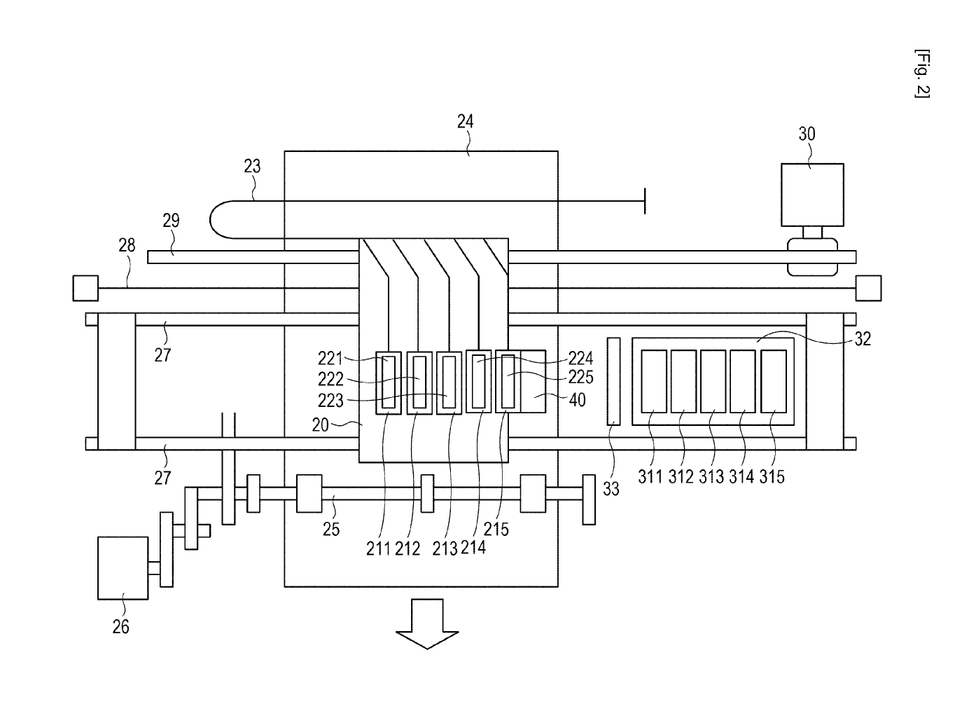

FIG. 2 is a schematic view of an ink jet recording apparatus according to an embodiment of the present invention. A plurality of recording heads 211 to 215 of an ink jet system is mounted on a carriage 20. A plurality of ink ejection orifices configured to eject an ink are arranged in each of the recording heads 211 to 215. In an embodiment in which two-divided applications of a black ink are performed in one pass, reference numerals 211, 212, 213, 214, and 215 denote exemplary recording heads configured to eject black (K), cyan (C), magenta (M), yellow (Y), and black (K) inks, respectively. Ink cartridges 221 to 225 include the respective recording heads 211 to 215 and ink tanks configured to feed inks to these recording heads. Reference numeral 40 denotes a concentration sensor. The concentration sensor 40 is a reflection type concentration sensor. The concentration sensor 40 is arranged on a side surface of the carriage 20 and can detect the density of a test pattern recorded on a recording medium in a state provided. For example, control signals to the recording heads 211 to 215 are transferred through a flexible cable 23. A recording medium 24, such as plain paper, with cellulose fibers that are exposed is held by eject rollers 25 via conveying rollers (not illustrated) and conveyed in a direction (secondary scanning direction) of an arrow by driving a convey motor 26. The carriage 20 is guided and supported by a guide shaft 27 and a linear encoder 28. The carriage 20 is reciprocated in a main scanning direction along the guide shaft 27 through a drive belt 29 by driving a carriage motor 30. A heating element (electricity-thermal energy converter) configured to generate thermal energy for ink ejection is provided in the inside (liquid path) of each of the ink ejection orifices of the recording heads 211 to 215. The heating element is driven on the basis of a recording signal according to reading timing of the linear encoder 28 to eject and apply ink droplets to the recording medium, thereby forming an image. A recovery unit 32 having cap parts 311 to 315 is provided at a home position of the carriage 20 arranged outside a recording region. When recording is not conducted, the carriage 20 is moved to the home position, and the faces of the ink ejection orifices of the recording heads 211 to 215 are closed by their corresponding caps 311 to 315, thereby preventing sticking of the inks caused by evaporation of ink solvents and clogging by adhesion of a foreign substance such as dust. The capping function of the cap parts is used to eliminate ejection failure and clogging of ejection orifices low in recording frequency. Specifically, the capping parts are used for blank ejection for preventing ejection failure, in which the inks are ejected to the cap parts located in a state separated from the ink ejection openings. Furthermore, the cap parts are utilized for sucking the inks from the ink ejection orifices in a capped state by a pump (not illustrated) to recover ejection of ejection orifices undergone ejection failure. An ink receiving part 33 plays the role in receiving ink droplets preliminarily ejected when the recording heads 211 to 215 pass through over it just before recording operation. A blade or wiping member (not illustrated) is arranged at a position adjoining the cap parts, whereby the ink ejection opening-forming faces of the recording heads 211 to 215 can be cleaned.

As described above, the addition of the recovery unit for recording heads and preliminary units to the configuration of the recording apparatus can results in the more stabilization of the recording operation. Specific examples of these units include capping units, cleaning units and pressurizing or sucking units for recording heads, and preliminary heating units by electric thermal conversion members, other heating elements than these converters or combinations thereof. It is also effective for stably conducting recording to provide a preliminary ejection mode that ejection separate from recording is conducted. In addition, a cartridge type recording head, in which an ink tank is provided integrally with the recording head itself described in the above-described embodiment may also be used. Furthermore, a replaceable chip type recording head, in which electrical connection to an apparatus body and the feed of an ink from the apparatus body become feasible by installing it in the apparatus body, may also be used.

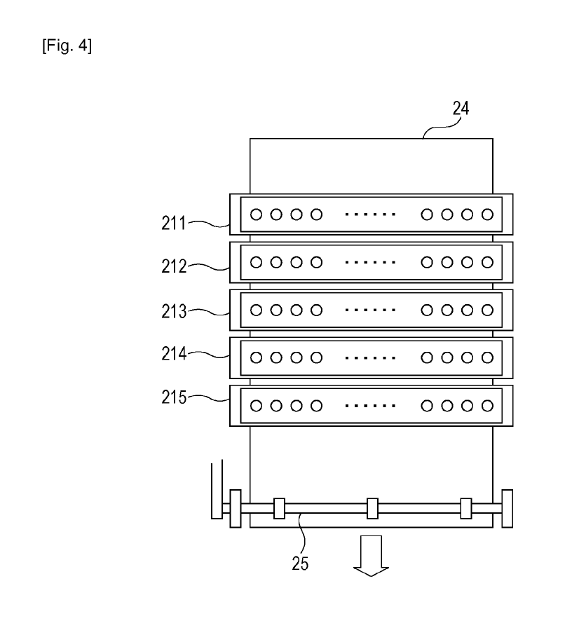

The recording head illustrated in FIG. 3 is a head of the serial type in which a recording head is scanned to conduct recording. However, a recording head of the full-line type may be used in which a recording head having a length corresponding to the width of a recording medium is used. With respect to a recording head of the full-line type, as illustrated in FIG. 4, such recording heads of the serial type are arranged in a staggered state or in parallel to form a continuous recording head so as to give the intended length. Alternatively, one recording head integrally formed so as to have a continuous nozzle row may also be used.

In the above-described recording apparatus of the serial type or line type according to this embodiment, the head including five ejection orifice rows (or nozzle rows) independently or integrally formed is arranged using four color inks (Y, M, C, and K), in which in order to perform two-divided applications of only the black ink, the nozzles of the recording heads 211 and 215 are used for the black ink. According to an embodiment in which divided applications are performed with four ejection orifice rows (or nozzle rows), with respect to at least one of four color inks (Y, M, C, and K), inks of the same color can be duplicatively charged in plural ejection orifice rows (or nozzle rows). Examples thereof include configuration of eight ejection orifice rows (or nozzle rows) and configuration of 12 ejection orifice rows (or nozzle rows) in which two or three heads with the four ejection orifice rows (or nozzle rows) are continuously connected.

According to the ink jet recording apparatus according to aspects of the present invention, the application of the ink can be divided into plural times when an image having a portion where the duty is 80% or more and the total amount of an ink applied is 5.0 microliters per square centimeter or less is formed in a basic matrix configured to form the image. The amount of the ink applied at each of the times divided can be set to 0.7 microliters per square centimeter or less. The ink jet recording apparatus according to the aspects of the present invention has a control mechanism configured to conduct such divided application of ink. The operation of the ink jet recording head and the timing of paper-feed operation of plain paper are controlled by this control mechanism to conduct such divided application of ink.

### Recording Medium

A recording medium for use in aspects of the present invention will be described below. Examples of the recording medium include plain paper and glossy photo paper for photographs for use in homes and offices; and printing paper for use in printing industry.

Plain paper is defined as paper that does not have a specialized functional layer or the like on a surface thereof. Typical examples of plain paper include copying paper, such as commercially available wood free paper, medium grade paper, and PPC paper, and bond paper, which are used in a large amount in printers, copying machines, and so forth. Specific examples thereof include Office Planner paper for common use in PPC/BJ, White Recycled Paper EW-100, and PB PAPER GF-500 (products of Canon Marketing Japan Inc).

Glossy photo paper is defined as paper having an ink-receiving layer on a base. Specific examples thereof include PT-101, PR-201, PR-101, GL-101, SG-201, GP-501, and MP-101 (products of Canon Marketing Japan Inc). In addition, Matte Photo paper MP-1011 (manufactured by Canon Marketing Japan Inc) is exemplified.

Printing paper is categorized into printing paper that has a coating layer and printing paper that does not have a coating layer. The coating layer is a layer of a coating composition applied on a front surface and/or back surface of wood free paper or medium grade paper, or a coating composition layer formed on a front surface or during papermaking in order to increase an aesthetic impression and smoothness of a surface of paper.

Specific examples of printing paper that does not have a coating layer include OK Woodfree Paper and OK Prince Woodfree Paper (products of Oji paper Co., Ltd).

According to “Census of manufactures” of Ministry of Economy, Trade and Industry, and the “Classification table of paper and cardboard” in “Paper and cardboard statistics annual report” of Japan Paper Association, printing paper having a coating layer is classified into “coated printing paper” and “ultra lightweight coat paper” in “industrial- and office-use printing paper”. For the “coated printing paper”, about 15 g/m² to 40 g/m² of a coating composition is applied to both surfaces to form coating layers. For the “ultra lightweight coat paper”, 12 g/m² or less of a coating composition is applied to both surfaces to form coating layers. “Coated printing paper” is categorized into art paper, coated paper, light weight coat paper, others (cast-coated paper and embossed paper), and so forth on the basis of the amount of the coating composition and a method of surface treatment after the application. Furthermore, on the basis of a difference in surface glossiness, “coated printing paper” is categorized into a gloss group, a matte group, dull group, and the like. Specific examples of “coated printing paper” include art paper, such as OK Ultra Aqua satin, OK Kinfuji, SA Kinfuji, and Satin Kinfuji (products of Oji paper Co. Ltd.), Hyperpyrene and Silverdia (products of Nippon Paper Industries Co., Ltd.), Green Utrillo (product of Daio Paper Corp.), Pearl Coat and New V matte (products of Mitsubishi Paper Mills Limited), Raicho Super Art (product of Chuetsu Pulp & Paper Co., Ltd.), and High McKinley (product of Gojo Paper MFG. Co. Ltd.); coat paper, such as OK Topcoat, OK Topcoat Dull, OK Topcoat Matte, OK Trinity, and OK Casablanca (products of Oji paper Co., Ltd.), Aurora Coat, Silverdia, and Shorai Matte (products of Nippon Paper Industries Co., Ltd.), Green Utrillo (product of Daio Paper Corp.), and Pearl Coat and New V matte (products of Mitsubishi Paper Mills Limited); light weight coat paper, such as OK Coat L (products of Oji paper Co. Ltd.), Aurora L, Easter DX, and Pegasus (products of Nippon Paper Industries Co., Ltd.), Utrillo Coat L (product of Daio Paper Corp.), Pearl Coat L (product of Mitsubishi Paper Mills Limited), Super Emine (product of Chuetsu Pulp & Paper Co., Ltd.), and Dream Coat (product of Marusumi Paper Co. Ltd.); and cast-coated paper, such as Mirror Coat Platinum and OK Chrome (products of Oji paper Co. Ltd.), Esprit Coat (product of Nippon Paper Industries Co., Ltd.), and Picasso Coat (product of Daio Paper Corp). Specific examples of “ultra lightweight coat paper” include OK Ever Light, OK Crystal, and OK Prunus White (products of Oji paper Co. Ltd.), Pyrene DX and Aurora S (products of Nippon Paper Industries Co., Ltd).

### EXAMPLES

The present invention will be specifically described below specifically by examples and comparative examples. Incidentally, all designations of “part” or “parts” and “%” in the following examples indicate part or parts by mass and % by mass unless expressly noted. The average particle size was measured with Nanotrac UPA 150EX (manufactured by NIKKISO CO., LTD., using a 50% cumulative value of a volume-weighted mean diameter). The acid value was determined in the form of an aqueous dispersion of the polymer particles using a potentiometric titration meter (Titrino potentiometric titration meter, manufactured by Metrohm AG). The glass transition temperature was measured with DSC822 (manufactured by METTLER TOLEDO). The weight-average molecular weight was measured with HLC-8220 GPC (manufactured by Tosoh Corporation).

### Self-Dispersing Pigment

As black self-dispersing pigments, CAB-O-JET 400 (manufactured by Cabot Corporation), CAB-O-JET 300 (manufactured by Cabot Corporation), BONJET BLACK CW-2 (manufactured by Orient Chemical Industries Co., Ltd.) were used. As color self-dispersing pigments, CAB-O-JET 470Y (manufactured by Cabot Corporation) for yellow, CAB-O-JET 465M (manufactured by Cabot Corporation) for magenta, and CAB-O-JET 450C (manufactured by Cabot Corporation) for cyan were used.

### Polymer Particles 1

According to the exemplary production of the polymer particles, polymerization was performed with styrene/n-butyl acrylate/acrylic acid (4.5/4.5/1.5 (mass ratio)) and sodium dodecyl sulfate (0.25 (mass ratio)) as predetermined monomers. After the completion of the polymerization, purification and concentration were performed to give a dispersion of polymer particles 1, the dispersion having a solid concentration of 10% by mass. The pH was adjusted to 8.5. The polymer particles 1 had an average particle size (D50) of 95 nm, an acid value of 100 mgKOH/g, a glass transition temperature (Tg) of 21 degrees (Celsius), and a weight-average molecular weight (Mw) of 1,030,000.

### Polymer Particles 2

According to the exemplary production of the polymer particles, polymerization was performed with styrene/n-butyl acrylate/acrylic acid (3.0/6.0/1.5 (mass ratio)) and sodium dodecyl sulfate (0.25 (mass ratio)) as predetermined monomers. After the completion of the polymerization, purification and concentration were performed to give a dispersion of polymer particles 2, the dispersion having a solid concentration of 10% by mass. The pH was adjusted to 8.5. The polymer particles 2 had an average particle size (D50) of 122 nm, an acid value of 101 mgKOH/g, a glass transition temperature (Tg) of −3 degrees (Celsius), and a weight-average molecular weight (Mw) of 900,000.

### Polymer Particles 3

According to the exemplary production of the polymer particles, polymerization was performed with styrene/n-butyl acrylate/acrylic acid (3.0/6.0/1.5 (mass ratio)) and sodium dodecyl sulfate (0.15 (mass ratio)) as predetermined monomers. After the completion of the polymerization, purification and concentration were performed to give a dispersion of polymer particles 3, the dispersion having a solid concentration of 10% by mass. The pH was adjusted to 8.5. The polymer particles 3 had an average particle size (D50) of 132 nm, an acid value of 99 mgKOH/g, a glass transition temperature (Tg) of −5 degrees (Celsius), and a weight-average molecular weight (Mw) of 880,000.

### Polymer Particles 4

According to the exemplary production of the polymer particles, polymerization was performed with styrene/n-butyl acrylate/acrylic acid (3.0/6.0/1.5 (mass ratio)) and sodium dodecyl sulfate (0.1 (mass ratio)) as predetermined monomers. After the completion of the polymerization, purification and concentration were performed to give a dispersion of polymer particles 4, the dispersion having a solid concentration of 10% by mass. The pH was adjusted to 8.5. The polymer particles 4 had an average particle size (D50) of 148 nm, an acid value of 101 mgKOH/g, a glass transition temperature (Tg) of −3 degrees (Celsius), and a weight-average molecular weight (Mw) of 770,000.

### Polymer Particles 5 to 20

Similarly to the exemplary production of the polymer particles 1 to 4, polymerizations were performed with monomer compositions shown in Table 2. After the completion of the polymerization, purification and concentration were performed to give dispersions of polymer particles 5 to 20, each of the dispersions having a solid concentration of 10% by mass. Table 2 shows the average particle size (D50), the acid value, the glass transition temperature (Tg), and the weight-average molecular weight (Mw) of the polymer particles. In Table 2, St, MMA, nBA, EHA, AA, and MAA represent styrene, methyl methacrylate, n-butyl acrylate, 2-ethylhexyl acrylate, acrylic acid, and methacrylic acid, respectively.

TABLE 2

| | Synthesis condition | | | | | | | | |
|---|---|---|---|---|---|---|---|---|---|
| | | | | | Hydrophilic | | | Average particle | |
| | Hydrophobic monomer | | | | monomer | | | size | |
| | (mass ratio) | | | | (mass ratio) | | Tg | (D50) | Acid value |
| | St | MMA | nBA | EHA | AA | MAA | [° C.] | [nm] | [mgKOH/g] |
| Polymer particle 1 | 4.5 | — | 4.5 | — | 1.5 | — | 21 | 98 | 100 |
| Polymer particle 2 | 3.0 | — | 6.0 | — | 1.5 | — | −3 | 122 | 101 |
| Polymer particle 3 | 3.0 | — | 6.0 | — | 1.5 | — | −5 | 132 | 99 |
| Polymer particle 4 | 3.0 | — | 6.0 | — | 1.5 | — | −3 | 148 | 101 |
| Polymer particle 5 | 3.0 | — | 6.0 | — | 1.5 | — | −1 | 163 | 100 |
| Polymer particle 6 | 3.0 | — | 6.0 | — | 1.5 | — | 0 | 183 | 108 |
| Polymer particle 7 | 3.0 | — | 6.0 | — | 1.5 | — | −5 | 219 | 100 |
| Polymer particle 8 | 3.5 | — | 6.0 | — | 1.0 | — | −9 | 152 | 72 |
| Polymer particle 9 | 4.0 | — | 6.0 | — | 0.5 | — | −5 | 154 | 35 |
| Polymer particle 10 | 3.5 | — | — | 6.0 | — | 1.0 | 3 | 155 | 60 |
| Polymer particle 11 | — | 2.0 | 7.0 | — | — | 2.5 | −6 | 201 | 140 |
| Polymer particle 12 | — | 4.0 | — | 6.0 | 0.5 | — | 5 | 172 | 35 |
| Polymer particle 13 | 1.5 | — | 7.5 | — | 1.5 | — | −25 | 182 | 100 |
| Polymer particle 14 | 9.0 | — | — | — | 1.5 | — | 110 | 107 | 101 |
| Polymer particle 15 | 6.0 | — | 3.0 | — | 1.5 | — | 38 | 90 | 102 |
| Polymer particle 16 | 3.0 | — | 6.0 | — | 4.5 | — | 10 | 131 | 182 |
| Polymer particle 17 | 4.2 | — | 6.0 | — | 0.3 | — | −5 | 143 | 22 |
| Polymer particle 18 | 3.0 | — | 6.0 | — | 1.5 | — | −5 | 282 | 100 |
| Polymer particle 19 | 3.0 | — | 6.0 | — | 1.5 | — | −4 | 70 | 100 |
| Polymer particle 20 | 3.0 | — | 6.0 | — | 1.5 | — | −4 | 47 | 102 |

### Preparation of Ink

Preparation examples of inks for examples of the present invention and comparative examples will be described below. The preparation of the inks basically included the following operations: all components (100 parts in total) constituting each of the inks shown in Tables 3-1 to 3-6 (black ink) and Tables 4-1 to 4-5 (color ink) were mixed, stirred for 1 hour, and filtered with a filter having a pore size of 2.5 micrometers. Note that water shown in Tables indicates ion-exchanged water. Values of the self-dispersing pigments and the polymer particles 1 to 20 indicate solid concentrations. Acetylenol EH (manufactured by Kawaken Fine Chemicals Co., Ltd.) is an ethylene oxide adduct of acetylene glycol. The surface tensions of the inks were measured with CBVP-Z (trade name, manufactured by Kyowa Interface Science Co., Ltd). In this way, black inks 1 to 20 of Examples 1 to 20, color inks 1 to 13 of Examples 21 to 33, black inks 21 to 29 of Comparative Examples 1 to 9, and color inks 14 to 22 of Com- parative Examples 10 to 18 were prepared.

Furthermore, black inks 30 to 49 of Examples 34 to 53 were similarly prepared, except that the amounts of the pigments for black inks 1 to 20 of Examples 1 to 20 were each changed to 2.0 parts. Color inks 23 to 35 of Examples 54 to 66 were similarly prepared, except that the amounts of the pigments for color inks 1 to 13 of Examples 21 to 33 were each changed to 2.0 parts. Black inks 50 to 58 of Comparative Examples 19 to 27 were similarly prepared, except that the amounts of the pigments for black inks 21 to 29 of Comparative Examples 1 to 9 were each changed to 2.0 parts. Color inks 36 to 44 of Comparative Examples 28 to 36 were similarly prepared, except that the amounts of the pigments for color inks 14 to 22 of Comparative Examples 10 to 18 were each changed to 2.0 parts.

Values of the surface tension of these examples and comparative examples, in which the amounts of the pigments were each changed to 2.0 parts, were the same as values shown in Tables 4-1 to 4-5.

TABLE 3-1

| | Par- | | | | | |
|---|---|---|---|---|---|---|
| | ticle | | | | | |
| | size | Acid value | Tg | Example | | |
| | <nm> | <mgKOH/g> | <° C.> | 1 | 2 | 3 |
| Black ink | — | — | — | 1 | 2 | 3 |
| CAB-O-JET | — | — | — | 5.0 | 5.0 | 5.0 |
| 400 | | | | | | |
| CAB-O-JET | — | — | — | — | — | — |
| 300 | | | | | | |
| BONJET | — | — | — | — | — | — |
| BLACK | | | | | | |
| CW2 | | | | | | |
| Polymer | 95 | 100 | 21 | 2.0 | — | — |
| particle 1 | | | | | | |
| Polymer | 122 | 101 | −3 | — | 2.0 | — |
| particle 2 | | | | | | |
| Polymer | 132 | 99 | −5 | — | — | 2.0 |
| particle 3 | | | | | | |
| Polymer | 148 | 101 | −3 | — | — | — |
| particle 4 | | | | | | |
| Polymer | 163 | 100 | −1 | — | — | — |
| particle 5 | | | | | | |
| Polymer | 183 | 108 | 0 | — | — | — |
| particle 6 | | | | | | |
| Polymer | 219 | 100 | −5 | — | — | — |
| particle 7 | | | | | | |
| Polymer | 152 | 72 | −9 | — | — | — |
| particle 8 | | | | | | |
| Polymer | 154 | 35 | −5 | — | — | — |
| particle 9 | | | | | | |
| Polymer | 155 | 60 | 3 | — | — | — |
| particle 10 | | | | | | |
| Polymer | 201 | 140 | −6 | — | — | — |
| particle 11 | | | | | | |
| Polymer | 172 | 35 | 5 | — | — | — |
| particle 12 | | | | | | |
| Polymer | 182 | 100 | −25 | — | — | — |
| particle 13 | | | | | | |
| Polymer | 107 | 101 | 110 | — | — | — |
| particle 14 | | | | | | |
| Polymer | 90 | 102 | 38 | — | — | — |
| particle 15 | | | | | | |
| Polymer | 131 | 182 | 10 | — | — | — |
| particle 16 | | | | | | |
| Polymer | 143 | 22 | −5 | — | — | — |
| particle 17 | | | | | | |
| Polymer | 282 | 100 | −5 | — | — | — |
| particle 18 | | | | | | |
| Polymer | 70 | 100 | −4 | — | — | — |
| particle 19 | | | | | | |
| Polymer | 47 | 102 | −4 | — | — | — |
| particle 20 | | | | | | |
| Ammonium | — | — | — | — | 0.5 | 0.5 |
| phthalate | | | | | | |
| Sodium | — | — | — | 0.36 | — | — |
| sulfate | | | | | | |
| 1,2- | — | — | — | 5.0 | 5.0 | 5.0 |
| Hexanediol | | | | | | |
| 1,6- | — | — | — | — | — | — |
| Hexanediol | | | | | | |
| Trimethylol- | — | — | — | 15.0 | 15.0 | 15.0 |
| propane | | | | | | |
| Glycerol | — | — | — | — | — | — |
| Isopropanol | — | — | — | 1.0 | 1.0 | 1.0 |
| Acetylenol | — | — | — | 1.0 | 1.0 | 1.0 |
| EH | | | | | | |
| Water | — | — | — | Balance | Balance | Balance |
| pH | — | — | — | KOH | KOH | KOH |
| controlling | | | | | | |
| agent | | | | | | |
| Surface | — | — | — | 30 | 30 | 30 |
| tension | | | | | | |
| (mN/m) | | | | | | |

TABLE 3-2

| | Example | | | | | |
|---|---|---|---|---|---|---|
| | 4 | 5 | 6 | 7 | 8 | 9 |
| Black ink | 4 | 5 | 6 | 7 | 8 | 9 |
| CAB-O-JET | 5.0 | 5.0 | 5.0 | 5.0 | 5.0 | 5.0 |
| 400 | | | | | | |
| CAB-O-JET | — | — | — | — | — | — |
| 300 | | | | | | |
| BONJET | — | — | — | — | — | — |
| BLACK CW2 | | | | | | |
| Polymer | — | — | — | — | — | — |
| particle 1 | | | | | | |
| Polymer | — | — | — | — | — | — |
| particle 2 | | | | | | |
| Polymer | — | — | — | — | — | — |
| particle 3 | | | | | | |
| Polymer | 2.0 | — | — | — | — | — |
| particle 4 | | | | | | |
| Polymer | — | 2.0 | — | — | — | — |
| particle 5 | | | | | | |
| Polymer | — | | 2.0 | — | — | — |
| particle 6 | | | | | | |
| Polymer | — | — | — | 2.0 | — | — |
| particle 7 | | | | | | |
| Polymer | — | — | — | — | 2.0 | — |
| particle 8 | | | | | | |
| Polymer | — | — | — | — | — | 2.0 |
| particle 9 | | | | | | |
| Polymer | — | — | — | — | — | — |
| particle 10 | | | | | | |
| Polymer | — | — | — | — | — | — |
| particle 11 | | | | | | |
| Polymer | — | — | — | — | — | — |
| particle 12 | | | | | | |
| Polymer | — | — | — | — | — | — |
| particle 13 | | | | | | |
| Polymer | — | — | — | — | — | — |
| particle 14 | | | | | | |
| Polymer | — | — | — | — | — | — |
| particle 15 | | | | | | |
| Polymer | — | — | — | — | — | — |
| particle 16 | | | | | | |
| Polymer | — | — | — | — | — | — |
| particle 17 | | | | | | |
| Polymer | — | — | — | — | — | — |
| particle 18 | | | | | | |
| Polymer | — | — | — | — | — | — |
| particle 19 | | | | | | |
| Polymer | — | — | — | — | — | — |
| particle 20 | | | | | | |
| Ammonium | 0.5 | 0.5 | — | 0.5 | 0.5 | 0.5 |
| phthalate | | | | | | |
| Sodium sulfate | — | — | 0.36 | — | — | — |
| 1,2-Hexanediol | 5.0 | 5.0 | 5.0 | 5.0 | 5.0 | 5.0 |
| 1,6-Hexanediol | — | — | — | — | — | — |
| Trimethylol- | 15.0 | 15.0 | 15.0 | 15.0 | 15.0 | 15.0 |
| propane | | | | | | |
| Glycerol | — | — | — | — | — | — |
| Isopropanol | 1.0 | 1.0 | 1.0 | 1.0 | 1.0 | 1.0 |
| Acetylenol EH | 1.0 | 1.0 | 1.0 | 1.0 | 1.0 | 1.0 |
| Water | Balance | Balance | Balance | Balance | Balance | Balance |
| pH controlling | KOH | KOH | KOH | KOH | KOH | KOH |
| agent | | | | | | |
| Surface tension | 30 | 30 | 30 | 31 | 31 | 30 |
| (mN/m) | | | | | | |

TABLE 3-3

| | Example | | | | | |
|---|---|---|---|---|---|---|
| | 10 | 11 | 12 | 13 | 14 | 15 |
| Black ink | 10 | 11 | 12 | 13 | 14 | 15 |
| CAB-O-JET | 5.0 | 5.0 | 5.0 | 5.0 | 5.0 | 5.0 |
| 400 | | | | | | |
| CAB-O-JET | — | — | — | — | — | — |
| 300 | | | | | | |
| BONJET | — | — | — | — | — | — |
| BLACK CW2 | | | | | | |
| Polymer | — | — | — | — | — | — |
| particle 1 | | | | | | |
| Polymer | — | — | — | — | — | — |
| particle 2 | | | | | | |
| Polymer | — | — | — | — | — | — |
| particle 3 | | | | | | |
| Polymer | — | — | — | — | — | — |
| particle 4 | | | | | | |
| Polymer | — | — | — | — | — | — |
| particle 5 | | | | | | |
| Polymer | — | — | — | — | 2.0 | 2.0 |
| particle 6 | | | | | | |
| Polymer | — | — | — | — | — | — |
| particle 7 | | | | | | |
| Polymer | — | — | — | — | — | — |
| particle 8 | | | | | | |
| Polymer | — | — | — | — | — | — |
| particle 9 | | | | | | |
| Polymer | 2.0 | — | — | — | — | — |
| particle 10 | | | | | | |
| Polymer | — | 2.0 | — | — | — | — |
| particle 11 | | | | | | |
| Polymer | — | — | 2.0 | — | — | — |
| particle 12 | | | | | | |
| Polymer | — | — | — | 2.0 | — | — |
| particle 13 | | | | | | |
| Polymer | — | — | — | — | — | — |
| particle 14 | | | | | | |
| Polymer | — | — | — | — | — | — |
| particle 15 | | | | | | |
| Polymer | — | — | — | — | — | — |
| particle 16 | | | | | | |
| Polymer | — | — | — | — | — | — |
| particle 17 | | | | | | |
| Polymer | — | — | — | — | — | — |
| particle 18 | | | | | | |
| Polymer | — | — | — | — | — | — |
| particle 19 | | | | | | |
| Polymer | — | — | — | — | — | — |
| particle 20 | | | | | | |
| Ammonium | — | 0.5 | 0.5 | 0.5 | — | 0.5 |
| phthalate | | | | | | |
| Sodium sulfate | 0.36 | — | — | — | — | — |
| 1,2-Hexanediol | 5.0 | 5.0 | 5.0 | 5.0 | 5.0 | — |
| 1,6-Hexanediol | — | — | — | — | — | — |
| Trimethylol- | 15.0 | 15.0 | 15.0 | 15.0 | 15.0 | — |
| propane | | | | | | |
| Glycerol | — | — | — | — | — | 20.0 |
| Isopropanol | 1.0 | 1.0 | 1.0 | 1.0 | 1.0 | 1.0 |
| Acetylenol EH | 1.0 | 1.0 | 1.0 | 1.0 | 1.0 | 1.0 |
| Water | Balance | Balance | Balance | Balance | Balance | Balance |
| pH controlling | KOH | KOH | KOH | KOH | KOH | KOH |
| agent | | | | | | |
| Surface tension | 30 | 30 | 30 | 31 | 30 | 30 |
| (mN/m) | | | | | | |

TABLE 3-4

| | Example | | | | |
|---|---|---|---|---|---|
| | 16 | 17 | 18 | 19 | 20 |
| Black ink | 16 | 17 | 18 | 19 | 20 |
| CAB-O-JET 400 | 5.0 | — | — | — | — |
| CAB-O-JET 300 | — | 5.0 | 5.0 | — | — |
| BONJET BLACK CW2 | — | — | — | 5.0 | 5.0 |
| Polymer particle 1 | — | — | — | — | — |
| Polymer particle 2 | — | — | — | — | — |
| Polymer particle 3 | — | — | — | — | — |
| Polymer particle 4 | — | — | — | — | — |
| Polymer particle 5 | — | — | — | — | — |
| Polymer particle 6 | 2.0 | 2.0 | — | 2.0 | — |
| Polymer particle 7 | — | — | — | — | — |
| Polymer particle 8 | — | — | 2.0 | — | 2.0 |
| Polymer particle 9 | — | — | — | — | — |
| Polymer particle 10 | — | — | — | — | — |
| Polymer particle 11 | — | — | — | — | — |
| Polymer particle 12 | — | — | — | — | — |
| Polymer particle 13 | — | — | — | — | — |
| Polymer particle 14 | — | — | — | — | — |
| Polymer particle 15 | — | — | — | — | — |
| Polymer particle 16 | — | — | — | — | — |
| Polymer particle 17 | — | — | — | — | — |
| Polymer particle 18 | — | — | — | — | — |
| Polymer particle 19 | — | — | — | — | — |
| Polymer particle 20 | — | — | — | — | — |
| Ammonium phthalate | 0.5 | 0.5 | 0.5 | — | 0.5 |
| Sodium sulfate | — | — | — | 0.36 | — |
| 1,2-Hexanediol | — | 5.0 | 5.0 | 5.0 | 5.0 |
| 1,6-Hexanediol | 20.0 | — | — | — | — |
| Trimethylolpropane | — | 15.0 | 15.0 | 15.0 | 15.0 |
| Glycerol | — | — | — | — | — |
| Isopropanol | 1.0 | 1.0 | 1.0 | 1.0 | 1.0 |
| Acetylenol EH | 1.0 | 1.0 | 1.0 | 1.0 | 1.0 |
| Water | Balance | Balance | Balance | Balance | Balance |
| pH controlling agent | KOH | KOH | KOH | KOH | KOH |
| Surface tension (mN/m) | 37 | 30 | 30 | 30 | 29 |

TABLE 3-5

| | Comparative Example | | | | | |
|---|---|---|---|---|---|---|
| | 1 | 2 | 3 | 4 | 5 | 6 |
| Black ink | 21 | 22 | 23 | 24 | 25 | 26 |
| CAB-O-JET | 5.0 | 5.0 | 5.0 | 5.0 | 5.0 | 5.0 |
| 400 | | | | | | |
| CAB-O-JET | — | — | — | — | — | — |
| 300 | | | | | | |
| BONJET | — | — | — | — | — | — |
| BLACK CW2 | | | | | | |
| Polymer | — | — | — | — | — | — |
| particle 1 | | | | | | |
| Polymer | — | — | — | — | — | — |
| particle 2 | | | | | | |
| Polymer | — | — | — | — | — | — |
| particle 3 | | | | | | |
| Polymer | — | — | — | — | — | — |
| particle 4 | | | | | | |
| Polymer | — | — | — | — | — | — |
| particle 5 | | | | | | |
| Polymer | — | — | — | — | — | — |
| particle 6 | | | | | | |
| Polymer | — | — | — | — | — | — |
| particle 7 | | | | | | |
| Polymer | — | — | — | — | — | — |
| particle 8 | | | | | | |
| Polymer | — | — | — | — | — | — |
| particle 9 | | | | | | |
| Polymer | — | — | — | — | — | — |
| particle 10 | | | | | | |
| Polymer | — | — | — | — | — | — |
| particle 11 | | | | | | |
| Polymer | — | — | — | — | — | — |
| particle 12 | | | | | | |
| Polymer | — | — | — | — | — | — |
| particle 13 | | | | | | |
| Polymer | 2.0 | — | — | — | — | — |
| particle 14 | | | | | | |
| Polymer | — | 2.0 | — | — | — | — |
| particle 15 | | | | | | |
| Polymer | — | — | 2.0 | — | — | — |
| particle 16 | | | | | | |
| Polymer | — | — | — | 2.0 | — | — |
| particle 17 | | | | | | |
| Polymer | — | — | — | — | 2.0 | — |
| particle 18 | | | | | | |
| Polymer | — | — | — | — | — | 2.0 |
| particle 19 | | | | | | |
| Polymer | — | — | — | — | — | — |
| particle 20 | | | | | | |
| Ammonium | — | 0.5 | 0.5 | 0.5 | 0.5 | 0.5 |
| phthalate | | | | | | |
| Sodium sulfate | 0.36 | — | — | — | — | — |
| 1,2-Hexanediol | 5.0 | 5.0 | 5.0 | 5.0 | 5.0 | 5.0 |
| 1,6-Hexanediol | — | — | — | — | — | — |
| Trimethylol- | 15.0 | 15.0 | 15.0 | 15.0 | 15.0 | 15.0 |
| propane | | | | | | |
| Glycerol | — | — | — | — | — | — |
| Isopropanol | 1.0 | 1.0 | 1.0 | 1.0 | 1.0 | 1.0 |
| Acetylenol EH | 1.0 | 1.0 | 1.0 | 1.0 | 1.0 | 1.0 |
| Water | Balance | Balance | Balance | Balance | Balance | Balance |
| pH controlling | KOH | KOH | KOH | KOH | KOH | KOH |
| agent | | | | | | |
| Surface tension | 30 | 30 | 30 | 30 | 30 | 30 |
| (mN/m) | | | | | | |

TABLE 3-6

| | Comparative Example | | |
|---|---|---|---|
| | 7 | 8 | 9 |
| Black ink | 27 | 28 | 29 |
| CAB-O-JET 400 | 5.0 | — | — |
| CAB-O-JET 300 | — | 5.0 | — |
| BONJET BLACK CW2 | — | — | 5.0 |
| Polymer particle 1 | — | — | — |
| Polymer particle 2 | — | — | — |
| Polymer particle 3 | — | — | — |
| Polymer particle 4 | — | — | — |
| Polymer particle 5 | — | — | — |
| Polymer particle 6 | — | — | — |
| Polymer particle 7 | — | — | — |
| Polymer particle 8 | — | — | — |
| Polymer particle 9 | — | — | — |
| Polymer particle 10 | — | — | — |
| Polymer particle 11 | — | — | — |
| Polymer particle 12 | — | — | — |
| Polymer particle 13 | — | — | — |
| Polymer particle 14 | — | — | — |
| Polymer particle 15 | — | 2.0 | — |
| Polymer particle 16 | — | — | — |
| Polymer particle 17 | — | — | — |
| Polymer particle 18 | — | — | 2.0 |
| Polymer particle 19 | — | — | — |
| Polymer particle 20 | 2.0 | — | — |
| Ammonium phthalate | 0.5 | 0.5 | 0.5 |
| Sodium sulfate | — | — | — |
| 1,2-Hexanediol | 5.0 | 5.0 | 5.0 |
| 1,6-Hexanediol | — | — | — |
| Trimethylolpropane | 15.0 | 15.0 | 15.0 |
| Glycerol | — | — | — |
| Isopropanol | 1.0 | 1.0 | 1.0 |
| Acetylenol EH | 1.0 | 1.0 | 1.0 |
| Water | Balance | Balance | Balance |
| pH controlling agent | KOH | KOH | KOH |
| Surface tension (mN/m) | 30 | 31 | 29 |

TABLE 4-1

| | Par- | | | | | |
|---|---|---|---|---|---|---|
| | ticle | | | | | |
| | size | Acid value | Tg | Example | | |
| | <nm> | <mgKOH/g> | <° C.> | 21 | 22 | 23 |
| Color ink | — | — | — | 1 | 2 | 3 |
| CAB-O-JET | — | — | — | 4.0 | 4.0 | 4.0 |
| 470Y | | | | | | |
| CAB-O-JET | — | — | — | — | — | — |
| 465M | | | | | | |
| BONJET | — | — | — | — | — | — |
| 450C | | | | | | |
| Polymer | 95 | 100 | 21 | 2.0 | — | — |
| particle 1 | | | | | | |
| Polymer | 122 | 101 | −3 | — | 2.0 | — |
| particle 2 | | | | | | |
| Polymer | 132 | 99 | −5 | — | — | 2.0 |
| particle 3 | | | | | | |
| Polymer | 148 | 101 | −3 | — | — | — |
| particle 4 | | | | | | |
| Polymer | 163 | 100 | −1 | — | — | — |
| particle 5 | | | | | | |
| Polymer | 183 | 108 | 0 | — | — | — |
| particle 6 | | | | | | |
| Polymer | 219 | 100 | −5 | — | — | — |
| particle 7 | | | | | | |
| Polymer | 152 | 72 | −9 | — | — | — |
| particle 8 | | | | | | |
| Polymer | 154 | 35 | −5 | — | — | — |
| particle 9 | | | | | | |
| Polymer | 155 | 60 | 3 | — | — | — |
| particle 10 | | | | | | |
| Polymer | 201 | 140 | −6 | — | — | — |
| particle 11 | | | | | | |
| Polymer | 172 | 35 | 5 | — | — | — |
| particle 12 | | | | | | |
| Polymer | 182 | 100 | −25 | — | — | — |
| particle 13 | | | | | | |
| Polymer | 107 | 101 | 110 | — | — | — |
| particle 14 | | | | | | |
| Polymer | 90 | 102 | 38 | — | — | — |
| particle 15 | | | | | | |
| Polymer | 131 | 182 | 10 | — | — | — |
| particle 16 | | | | | | |
| Polymer | 143 | 22 | −5 | — | — | — |
| particle 17 | | | | | | |
| Polymer | 282 | 100 | −5 | — | — | — |
| particle 18 | | | | | | |
| Polymer | 70 | 100 | −4 | — | — | — |
| particle 19 | | | | | | |
| Polymer | 47 | 102 | −4 | — | — | — |
| particle 20 | | | | | | |
| Ammonium | — | — | — | — | — | — |
| phthalate | | | | | | |
| Sodium | — | — | — | — | — | — |
| sulfate | | | | | | |
| 1,2- | — | — | — | 5.0 | 5.0 | 5.0 |
| Hexanediol | | | | | | |
| Trimethylol- | — | — | — | 15.0 | 15.0 | 15.0 |
| propane | | | | | | |
| Isopropanol | — | — | — | 1.0 | 1.0 | 1.0 |
| Acetylenol | — | — | — | 1.0 | 1.0 | 1.0 |
| EH | | | | | | |
| Water | — | — | — | Balance | Balance | Balance |
| pH | — | — | — | KOH | KOH | KOH |
| controlling | | | | | | |
| agent | | | | | | |
| Surface | — | — | — | 31 | 31 | 31 |
| tension | | | | | | |
| (mN/m) | | | | | | |

TABLE 4-2

| | Example | | | | | |
|---|---|---|---|---|---|---|
| | 24 | 25 | 26 | 27 | 28 | 29 |
| Color ink | 4 | 5 | 6 | 7 | 8 | 9 |
| CAB-O-JET | 4.0 | — | — | — | — | — |
| 470Y | | | | | | |
| CAB-O-JET | — | 4.0 | 4.0 | 4.0 | — | — |
| 465M | | | | | | |
| BONJET | — | — | — | — | 4.0 | 4.0 |
| 450C | | | | | | |
| Polymer | — | — | — | — | — | — |
| particle 1 | | | | | | |
| Polymer | — | — | — | — | — | — |
| particle 2 | | | | | | |
| Polymer | — | — | — | — | — | — |
| particle 3 | | | | | | |
| Polymer | 2.0 | — | — | — | — | — |
| particle 4 | | | | | | |
| Polymer | — | 2.0 | — | — | — | — |
| particle 5 | | | | | | |
| Polymer | — | — | 2.0 | — | — | — |
| particle 6 | | | | | | |
| Polymer | — | — | — | 2.0 | — | — |
| particle 7 | | | | | | |
| Polymer | — | — | — | — | 2.0 | — |
| particle 8 | | | | | | |
| Polymer | — | — | — | — | — | 2.0 |
| particle 9 | | | | | | |
| Polymer | — | — | — | — | — | — |
| particle 10 | | | | | | |
| Polymer | — | — | — | — | — | — |
| particle 11 | | | | | | |
| Polymer | — | — | — | — | — | — |
| particle 12 | | | | | | |
| Polymer | — | — | — | — | — | — |
| particle 13 | | | | | | |
| Polymer | — | — | — | — | — | — |
| particle 14 | | | | | | |
| Polymer | — | — | — | — | — | — |
| particle 15 | | | | | | |
| Polymer | — | — | — | — | — | — |
| particle 16 | | | | | | |
| Polymer | — | — | — | — | — | — |
| particle 17 | | | | | | |
| Polymer | — | — | — | — | — | — |
| particle 18 | | | | | | |
| Polymer | — | — | — | — | — | — |
| particle 19 | | | | | | |
| Polymer | — | — | — | — | — | — |
| particle 20 | | | | | | |
| Ammonium | — | 0.5 | — | 0.5 | — | — |
| phthalate | | | | | | |
| Sodium sulfate | — | — | 0.36 | — | — | — |
| 1,2-Hexanediol | 5.0 | 5.0 | 5.0 | 5.0 | 5.0 | 5.0 |
| Trimethylol- | 15.0 | 15.0 | 15.0 | 15.0 | 15.0 | 15.0 |
| propane | | | | | | |
| Isopropanol | 1.0 | 1.0 | 1.0 | 1.0 | 1.0 | 1.0 |
| Acetylenol EH | 1.0 | 1.0 | 1.0 | 1.0 | 1.0 | 1.0 |
| Water | Balance | Balance | Balance | Balance | Balance | Balance |
| pH controlling | KOH | KOH | KOH | KOH | KOH | KOH |
| agent | | | | | | |
| Surface tension | 31 | 31 | 31 | 32 | 31 | 32 |
| (mN/m) | | | | | | |

TABLE 4-3

| | Example | | | |
|---|---|---|---|---|
| | 30 | 31 | 32 | 33 |
| Color ink | 10 | 11 | 12 | 13 |
| CAB-O-JET 470Y | — | 4.0 | — | — |
| CAB-O-JET 465M | — | — | 4.0 | — |
| BONJET 450C | 4.0 | — | — | 4.0 |
| Polymer particle 1 | — | — | — | — |
| Polymer particle 2 | — | — | — | — |
| Polymer particle 3 | — | — | — | — |
| Polymer particle 4 | — | — | — | — |
| Polymer particle 5 | — | — | — | — |
| Polymer particle 6 | — | — | — | — |
| Polymer particle 7 | — | — | — | — |
| Polymer particle 8 | — | — | — | — |
| Polymer particle 9 | — | — | — | — |
| Polymer particle 10 | 2.0 | — | — | — |
| Polymer particle 11 | — | 2.0 | — | — |
| Polymer particle 12 | — | — | 2.0 | — |
| Polymer particle 13 | — | — | — | 2.0 |
| Polymer particle 14 | — | — | — | — |
| Polymer particle 15 | — | — | — | — |
| Polymer particle 16 | — | — | — | — |
| Polymer particle 17 | — | — | — | — |
| Polymer particle 18 | — | — | — | — |
| Polymer particle 19 | — | — | — | — |
| Polymer particle 20 | — | — | — | — |
| Ammonium phthalate | — | — | 0.5 | — |
| Sodium sulfate | — | — | — | — |
| 1,2-Hexanediol | 5.0 | 5.0 | 5.0 | 5.0 |
| Trimethylolpropane | 15.0 | 15.0 | 15.0 | 15.0 |
| Isopropanol | 1.0 | 1.0 | 1.0 | 1.0 |
| Acetylenol EH | 1.0 | 1.0 | 1.0 | 1.0 |
| Water | Balance | Balance | Balance | Balance |
| pH controlling agent | KOH | KOH | KOH | KOH |
| Surface tension (mN/m) | 30 | 32 | 30 | 30 |

TABLE 4-4

| | Comparative Example | | | | | |
|---|---|---|---|---|---|---|
| | 10 | 11 | 12 | 13 | 14 | 15 |
| Color ink | 14 | 15 | 16 | 17 | 18 | 19 |
| CAB-O-JET | 4.0 | 4.0 | 4.0 | — | — | — |
| 470Y | | | | | | |
| CAB-O-JET | — | — | — | 4.0 | 4.0 | 4.0 |
| 465M | | | | | | |
| BONJET | — | — | — | — | — | — |
| 450C | | | | | | |
| Polymer | — | — | — | — | — | — |
| particle 1 | | | | | | |
| Polymer | — | — | — | — | — | — |
| particle 2 | | | | | | |
| Polymer | — | — | — | — | — | — |
| particle 3 | | | | | | |
| Polymer | — | — | — | — | — | — |
| particle 4 | | | | | | |
| Polymer | — | — | — | — | — | — |
| particle 5 | | | | | | |
| Polymer | — | — | — | — | — | — |
| particle 6 | | | | | | |
| Polymer | — | — | — | — | — | — |
| particle 7 | | | | | | |
| Polymer | — | — | — | — | — | — |
| particle 8 | | | | | | |
| Polymer | — | — | — | — | — | — |
| particle 9 | | | | | | |
| Polymer | — | — | — | — | — | — |
| particle 10 | | | | | | |
| Polymer | — | — | — | — | — | — |
| particle 11 | | | | | | |
| Polymer | — | — | — | — | — | — |
| particle 12 | | | | | | |
| Polymer | — | — | — | — | — | — |
| particle 13 | | | | | | |
| Polymer | — | — | — | — | 2.0 | — |
| particle 14 | | | | | | |
| Polymer | — | — | — | — | — | — |
| particle 15 | | | | | | |
| Polymer | 2.0 | — | — | — | — | — |
| particle 16 | | | | | | |
| Polymer | — | 2.0 | — | 2.0 | — | — |
| particle 17 | | | | | | |
| Polymer | — | — | — | — | — | 2.0 |
| particle 18 | | | | | | |
| Polymer | — | — | 2.0 | — | — | — |
| particle 19 | | | | | | |
| Polymer | — | — | — | — | — | — |
| particle 20 | | | | | | |
| Ammonium | — | — | — | 0.5 | 0.5 | — |
| phthalate | | | | | | |
| Sodium sulfate | — | — | — | — | — | 0.36 |
| 1,2-Hexanediol | 5.0 | 5.0 | 5.0 | 5.0 | 5.0 | 5.0 |
| Trimethylol- | 15.0 | 15.0 | 15.0 | 15.0 | 15.0 | 15.0 |
| propane | | | | | | |
| Isopropanol | 1.0 | 1.0 | 1.0 | 1.0 | 1.0 | 1.0 |
| Acetylenol EH | 1.0 | 1.0 | 1.0 | 1.0 | 1.0 | 1.0 |
| Water | Balance | Balance | Balance | Balance | Balance | Balance |
| pH controlling | KOH | KOH | KOH | KOH | KOH | KOH |
| agent | | | | | | |
| Surface tension | 31 | 31 | 39 | 31 | 30 | 31 |
| (mN/m) | | | | | | |

TABLE 4-5

| | Comparative Example | | |
|---|---|---|---|
| | 16 | 17 | 18 |
| Color ink | 20 | 21 | 22 |
| CAB-O-JET 470Y | — | — | — |
| CAB-O-JET 465M | — | — | — |
| BONJET 450C | 4.0 | 4.0 | 4.0 |
| Polymer particle 1 | — | — | — |
| Polymer particle 2 | — | — | — |
| Polymer particle 3 | — | — | — |
| Polymer particle 4 | — | — | — |
| Polymer particle 5 | — | — | — |
| Polymer particle 6 | — | — | — |
| Polymer particle 7 | — | — | — |
| Polymer particle 8 | — | — | — |
| Polymer particle 9 | — | — | — |
| Polymer particle 10 | — | — | — |
| Polymer particle 11 | — | — | — |
| Polymer particle 12 | — | — | — |
| Polymer particle 13 | — | — | — |
| Polymer particle 14 | — | 2.0 | — |
| Polymer particle 15 | — | — | 2.0 |
| Polymer particle 16 | — | — | — |
| Polymer particle 17 | — | — | — |
| Polymer particle 18 | — | — | — |
| Polymer particle 19 | — | — | — |
| Polymer particle 20 | 2.0 | — | — |
| Ammonium phthalate | — | — | — |
| Sodium sulfate | — | — | — |
| 1,2-Hexanediol | 5.0 | 5.0 | 5.0 |
| Trimethylolpropane | 15.0 | 15.0 | 15.0 |
| Isopropanol | 1.0 | 1.0 | 1.0 |
| Acetylenol EH | 1.0 | 1.0 | 1.0 |
| Water | Balance | Balance | Balance |
| pH controlling agent | KOH | KOH | KOH |
| Surface tension (mN/m) | 32 | 31 | 31 |

### Examples 1 to 66 and Comparative Examples 1 to 36

### Evaluation of Dispersion Stability

The inks prepared in Examples 1 to 66 and Comparative Examples 1 to 36 were allowed to stand at room temperature for 10 days. The state of aggregation of the polymer particles was visually evaluated in accordance with criteria described below:
a. No aggregation is observed.
b. Aggregation is slightly observed.
c. Aggregation is apparently observed, and some precipitation occurs.

### Evaluation of Recorded Image

Next, images were formed with the inks prepared in Examples 1 to 66 and Comparative Examples 1 to 36. Specifically, the black inks were charged in a black ink head part and a cyan head part of a printer and applied from each ink head part in a duty of 50% to form six rows of solid images (3 cm long×5 cm wide) with a duty of 100% as recorded images. Each of the color inks was charged in a black ink head part and applied in a duty of 100% to form six rows of solid images (3 cm long×5 cm wide) with a duty of 100% as recorded images.

As the printer, BJ F900 (manufactured by Canon Inc.; recording head: six ejection orifice rows 6, including 512 nozzles in each row; the amount of the ink: 4.0 pl (fixed amount); and the maximum resolution of the basic matrix: 1,200 dpi (width)×1,200 dpi (length))) was used. The inks were ejected onto plain paper PB PAPER GF-500 (product of Canon Marketing Japan Inc.), glossy photo paper PR-101 (product of Canon Marketing Japan Inc.), and printing paper OK Topcoat (product of Oji paper Co. Ltd).

### Ejection Stability

The state of each of the recorded images was evaluated in accordance with criteria described below. The evaluation of ejection stability was made using an image formed on plain paper PB PAPER GF-500 (product of Canon Marketing Japan Inc).
aa. In each of the solid images, no unprinted portion (faded portion in the recorded images) is observed.
a. In the solid image formed in the second row, no unprinted portion is observed, but in the solid image formed in the first row, only a few unprinted portions are observed.
b. In each of the solid images, some unprinted portions are observed.
c. In each of the solid images, many unprinted portions are observed.
d. Most of the solid images are not printed.

### Fastness Property <Highlighter Resistance>

The recorded images, which had been formed on plain paper PB PAPER GF-500 using inks of Examples 1 to 33 and Comparative Examples 1 to 18, were marked with a highlighter (trade name: OPTEX 2, manufactured by Zebra Co., Ltd.) at a normal writing pressure 1 and 10 minutes after printing. The degree of tailing of each ink from the boundary between each recorded image and an unrecorded portion was visually evaluated in accordance with criteria described below.
a. Tailing is not observed, and the tip of the highlighter is not smudged.
b. Tailing is not observed, but the tip of the highlighter is slightly smudged.
c. Slight tailing is observed.
d. Tailing is apparently observed.
-. Evaluation cannot be made because the images are not printed.

### Fastness Property <Scratch Resistance>

The recorded images, which had been formed on glossy photo paper PR-101 (product of Canon Marketing Japan Inc.) and OK Topcoat (product of Oji paper Co. Ltd.) using inks of Examples 34 to 66 and Comparative Examples 19 to 36, were scratched once with lens-cleaning paper at a normal writing pressure 1 minute after printing for PR-101 and 2 days after printing for OK Topcoat. The degrees of fading of the inks of the recorded images were visually evaluated in accordance with criteria described below.
a. Fading is not observed, and the lens-cleaning paper is not smudged.
b. Fading is not observed, but the lens-cleaning paper is slightly smudged.
c. Fading is slightly observed.
d. Fading is apparently observed.
-. Evaluation cannot be made because the images are not printed.

Tables 5 to 8 show the evaluation results.

TABLE 5

| | | | | Highlighter resistance | |
|---|---|---|---|---|---|
| | | | | 1 minute | 10 minutes |
| | | Dispersion | Ejection | after | after |
| | Black ink | stability | property | printing | printing |
| Example 1 | 1 | a | a | b | a |
| Example 2 | 2 | a | a | a | a |
| Example 3 | 3 | a | aa | a | a |
| Example 4 | 4 | a | aa | a | a |
| Example 5 | 5 | a | aa | a | a |
| Example 6 | 6 | a | aa | a | a |
| Example 7 | 7 | a | aa | b | a |
| Example 8 | 8 | a | aa | a | a |
| Example 9 | 9 | a | aa | a | a |
| Example 10 | 10 | a | aa | a | a |
| Example 11 | 11 | a | aa | a | a |
| Example 12 | 12 | a | aa | a | a |
| Example 13 | 13 | a | aa | a | a |
| Example 14 | 14 | a | aa | b | a |
| Example 15 | 15 | a | aa | a | a |
| Example 16 | 16 | a | aa | b | a |
| Example 17 | 17 | a | aa | a | a |
| Example 18 | 18 | a | aa | a | a |
| Example 19 | 19 | a | aa | a | a |
| Example 20 | 20 | a | aa | a | a |
| Comparative | 21 | a | a | d | b |
| Example 1 | | | | | |
| Comparative | 22 | a | a | c | b |
| Example 2 | | | | | |
| Comparative | 23 | a | d | — | — |
| Example 3 | | | | | |
| Comparative | 24 | b | b | a | a |
| Example 4 | | | | | |
| Comparative | 25 | b | aa | c | b |
| Example 5 | | | | | |
| Comparative | 26 | a | c | — | — |
| Example 6 | | | | | |
| Comparative | 27 | a | d | — | — |
| Example 7 | | | | | |
| Comparative | 28 | a | a | c | b |
| Example 8 | | | | | |
| Comparative | 29 | b | aa | c | b |
| Example 9 | | | | | |

TABLE 6

| | | | | Highlighter resistance | |
|---|---|---|---|---|---|
| | | | | 1 minute | 10 minutes |
| | | Dispersion | Ejection | after | after |
| | Color ink | stability | property | printing | printing |
| Example 21 | 1 | a | a | b | a |
| Example 22 | 2 | a | a | a | a |
| Example 23 | 3 | a | aa | a | a |
| Example 24 | 4 | a | aa | a | a |
| Example 25 | 5 | a | aa | a | a |
| Example 26 | 6 | a | aa | a | a |
| Example 27 | 7 | a | aa | b | a |
| Example 28 | 8 | a | aa | a | a |
| Example 29 | 9 | a | aa | a | a |
| Example 30 | 10 | a | aa | a | a |
| Example 31 | 11 | a | aa | a | a |
| Example 32 | 12 | a | aa | a | a |
| Example 33 | 13 | a | aa | a | a |
| Comparative | 14 | a | d | — | — |
| Example 10 | | | | | |
| Comparative | 15 | b | b | a | a |
| Example 11 | | | | | |
| Comparative | 16 | a | c | — | — |
| Example 12 | | | | | |
| Comparative | 17 | b | b | a | a |
| Example 13 | | | | | |
| Comparative | 18 | a | a | d | b |
| Example 14 | | | | | |
| Comparative | 19 | b | aa | b | b |
| Example 15 | | | | | |
| Comparative | 20 | a | d | — | — |
| Example 16 | | | | | |
| Comparative | 21 | a | a | d | b |
| Example 17 | | | | | |
| Comparative | 22 | a | a | c | b |
| Example 18 | | | | | |

The results shown in Table 5 demonstrate that the inks prepared in Examples 1 to 20 have excellent dispersion stability, ejection stability, and highlighter resistance when the inks are applied to plain paper, as compared with the inks prepared in Comparative Examples 1 to 9. The results shown in Table 6 demonstrate that the inks prepared in Examples 21 to 33 have excellent dispersion stability, ejection stability, and highlighter resistance when the inks are applied to plain paper, as compared with the inks prepared in Comparative Examples 10 to 18. This may be because the polymer particles contained in the examples have a glass transition temperature of 25 degrees (Celsius) or lower, an average particle size of 80 nm to 220 nm, and an acid value of 25 mgKOH/g to 150 mgKOH/g.

TABLE 7

| | | | | Scratch resistance | |
|---|---|---|---|---|---|
| | | Dispersion | Ejection | Glossy photo | Printing |
| | Black ink | stability | property | paper | paper |
| Example 34 | 30 | a | a | a | b |
| Example 35 | 31 | a | a | a | a |
| Example 36 | 32 | a | aa | a | a |
| Example 37 | 33 | a | aa | a | a |
| Example 38 | 34 | a | aa | a | a |
| Example 39 | 35 | a | aa | a | a |
| Example 40 | 36 | a | aa | a | a |
| Example 41 | 37 | a | aa | a | a |
| Example 42 | 38 | a | aa | a | a |
| Example 43 | 39 | a | aa | a | a |
| Example 44 | 40 | a | aa | a | a |
| Example 45 | 41 | a | aa | a | a |
| Example 46 | 42 | a | aa | a | a |
| Example 47 | 43 | a | aa | a | b |
| Example 48 | 44 | a | aa | a | a |
| Example 49 | 45 | a | aa | a | b |
| Example 50 | 46 | a | aa | a | a |
| Example 51 | 47 | a | aa | a | a |
| Example 52 | 48 | a | aa | a | a |
| Example 53 | 49 | a | aa | a | a |
| Comparative | 50 | a | a | b | d |
| Example 19 | | | | | |
| Comparative | 51 | a | a | b | c |
| Example 20 | | | | | |
| Comparative | 52 | a | d | — | — |
| Example 21 | | | | | |
| Comparative | 53 | b | b | a | a |
| Example 22 | | | | | |
| Comparative | 54 | b | aa | c | c |
| Example 23 | | | | | |
| Comparative | 55 | a | c | — | — |
| Example 24 | | | | | |
| Comparative | 56 | a | d | — | — |
| Example 25 | | | | | |
| Comparative | 57 | a | e | c | b |
| Example 26 | | | | | |
| Comparative | 58 | b | aa | c | b |
| Example 27 | | | | | |

TABLE 8

| | | | | Scratch resistance | |
|---|---|---|---|---|---|
| | | Dispersion | Ejection | Glossy photo | Printing |
| | Color ink | stability | property | paper | paper |
| Example 54 | 23 | a | a | a | b |
| Example 55 | 24 | a | a | a | a |
| Example 56 | 25 | a | aa | a | a |
| Example 57 | 26 | a | aa | a | a |
| Example 58 | 27 | a | aa | a | a |
| Example 59 | 28 | a | aa | a | a |
| Example 60 | 29 | a | aa | a | b |
| Example 61 | 30 | a | aa | a | a |
| Example 62 | 31 | a | aa | a | a |
| Example 63 | 32 | a | aa | a | a |
| Example 64 | 33 | a | aa | a | a |
| Example 65 | 34 | a | aa | a | a |
| Example 66 | 35 | a | aa | a | a |
| Comparative | 36 | a | d | — | — |
| Example 28 | | | | | |
| Comparative | 37 | b | b | a | a |
| Example 29 | | | | | |
| Comparative | 38 | a | c | — | — |
| Example 30 | | | | | |
| Comparative | 39 | b | b | a | a |
| Example 31 | | | | | |
| Comparative | 40 | a | a | b | c |
| Example 32 | | | | | |
| Comparative | 41 | b | aa | b | b |
| Example 33 | | | | | |
| Comparative | 42 | a | d | — | — |
| Example 34 | | | | | |
| Comparative | 43 | a | a | b | c |
| Example 35 | | | | | |
| Comparative | 44 | a | a | b | c |
| Example 35 | | | | | |

The results shown in Table 7 demonstrate that the inks prepared in Examples 34 to 53 have excellent dispersion stability, ejection stability, and scratch resistance when the inks are applied to glossy photo paper and printing paper, as compared with the inks prepared in Comparative Examples 19 to 27. The results shown in Table 8 demonstrate that the inks prepared in Examples 54 to 66 have excellent dispersion stability, ejection stability, and scratch resistance when the inks are applied to glossy photo paper and printing paper, as compared with the inks prepared in Comparative Examples 28 to 36. This may be because the polymer particles contained in the examples have a glass transition temperature of 25 degrees (Celsius) or lower, an average particle size of 80 nm to 220 nm, and an acid value of 25 mgKOH/g to 150 mgKOH/g.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-267730, filed Nov. 25, 2009 and No. 2010-230727 filed Oct. 13, 2010, which are hereby incorporated by reference herein in their entirety.

1. An ink for ink jet recording, the ink being used in an ink jet recording method that includes ejecting ink from a recording head by the action of thermal energy, comprising:
water;
a self-dispersing pigment; and
polymer particles,
wherein the polymer particles have a glass transition temperature of 25 degrees (Celsius) or lower, an average particle size of 80 nm to 220 nm, and an acid value of 25 mgKOH/g to 150 mgKOH/g.

2. The ink for ink jet recording according to claim 1, further comprising:
an inorganic acid salt and/or an organic acid salt.

3. The ink for ink jet recording according to claim 1, further comprising:
at least one water-soluble compound having a coefficient of hydrophilicity-hydrophobicity of 0.26 or more,
wherein the coefficient of hydrophilicity-hydrophobicity is defined by Equation (A):
$$\begin{matrix}[ Math . 1 ] & \\ Coefficient of hydrophilicity - hydrophobicity = \frac{( \begin{matrix}water activity value \\ of 20 \% aqueous solution\end{matrix} ) - ( \begin{matrix}mole fraction of water \\ in 20 \% aqueous solution\end{matrix} )}{1 - ( \begin{matrix}mole fraction of water in \\ 20 \% aqueous solution\end{matrix} )} . & Equation ( A )\end{matrix}$$

4. The ink for ink jet recording according to claim 1, wherein the ink has a surface tension of 34 mN/m.

5. A thermal ink jet recording method comprising:
ejecting the ink for ink jet recording according to claim 1 from a recording head by the action of thermal energy.

6. A thermal ink jet recording method comprising:
applying the ink for ink jet recording according to claim 1 to a recording medium from a recording head by the action of thermal energy in a fixed amount of 0.5 pl to 6.0 pl to form an image,
wherein the application of the ink is divided into two or more times when an image having a portion where the ink is to be applied in a duty of 80% or more and in an amount of 5.0 microliters per square centimeter or less in total is to be formed in a basic matrix configured to form the image, and
wherein the amount of the ink applied at each of the times divided is 0.7 microliters per square centimeter or less.

7. A thermal ink jet recording apparatus comprising:
a recording head configured to eject the ink for ink jet recording according to claim 1 from the recording head onto a recording medium by the action of thermal energy to form an image.

8. A thermal ink jet recording apparatus comprising:
a recording head configured to apply the ink for ink jet recording according to claim 1 to a recording medium from a recording head by the action of thermal energy in a fixed amount of 0.5 pl to 6.0 pl to form an image; and
a control mechanism with which the application of the ink is divided into plural times when an image having a portion where the ink is to be applied in a duty of 80% or more and in an amount of 5.0 microliters per square centimeter or less in total is to be formed in a basic matrix configured to form the image, and with which the amount of the ink applied at each of the times divided is 0.7 microliters per square centimeter or less.
